(19) United States
(12) Patent Application Publication
(10) Pub. No.: US 2025/0348939 A1
(43) Pub. Date: Nov. 13, 2025

(54) APPARATUS, METHOD, AND COMPUTER PROGRAM PRODUCT FOR OUTPUTTING A RESOURCE DEVELOPMENT GENERATION INTERFACE COMPONENT TO A RESOURCE OPERATIONAL INTERFACE

(71) Applicant: ATLASSIAN US, INC., San Francisco, CA (US)

(72) Inventors: Chase Bradley NIELSON, Lehi, UT (US); Kelly Caroline SNOW, San Francisco, CA (US); Natalie ROWLAND, Sydney (AU); Alexander Quoc Dang DUONG, Boise, ID (US); Willy Henri DU PREEZ, Santa Clara, CA (US)

(21) Appl. No.: 18/657,030

(22) Filed: May 7, 2024

(51) Int. Cl. G06Q 40/06; G06Q 10/0631

(52) U.S. Cl. CPC G06Q 40/06; G06Q 10/0631

(57) ABSTRACT

Apparatus, methods, and computer program products for outputting a resource development generation interface component to a resource operational interface are provided. A method may include accessing resource unit development data representative of a plurality of refinement candidate resource unit development structures, generating a multi-dimensional refined resource unit development structure, generating a resource development generation interface component based at least in part on the multi-dimensional refined resource unit development structure, and outputting the resource development generation interface component for rendering to a resource operational interface of a computing device.

### BACKGROUND

Various methods, apparatuses, and systems provide tools for plan, collaborate, execute, address, resolve and monitor items and interface components in resource development environments. Applicant has identified a number of deficiencies and problems associated with tools for effectively, reliably, and securely managing items and interface components in a resource unit development operation system. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a resource unit development operation system, a resource development generation interface component to a resource operational interface.

In accordance with some exemplary embodiments of the present disclosure, an example apparatus is provided for outputting a resource development generation interface component to a resource operational interface is provided. In some embodiments, the apparatus may comprise at least one processor and at least one memory including program code. In some embodiments, the at least one memory and the program code are configured to, with the at least one processor, cause the apparatus to access resource unit development data representative of a plurality of refinement candidate resource unit development structures. In some embodiments, one or more of the plurality of refinement candidate resource unit development structures comprise at least one of a plurality of resource unit development items and at least one of a plurality of explicit resource unit development links. In some embodiments, the at least one memory and the program code are configured to, with the at least one processor, cause the apparatus to generate a multi-dimensional refined resource unit development structure comprising the plurality of resource unit development items, the plurality of explicit resource unit development links, and at least one predicted resource unit development link. In some embodiments, generating the multi-dimensional refined resource unit development structure comprises determining the at least one predicted resource unit development link. In some embodiments, the at least one memory and the program code are configured to, with the at least one processor, cause the apparatus to generate a resource development generation interface component based at least in part on the multi-dimensional refined resource unit development structure. In some embodiments, the resource development generation interface component comprises at least one of the plurality of resource unit development items. In some embodiments, generating the resource development generation interface component comprises selecting the at least one of the plurality of resource unit development items based at least in part on the at least one predicted resource unit development link. In some embodiments, the at least one memory and the program code are configured to, with the at least one processor, cause the apparatus to output the resource development generation interface component for rendering to a resource operational interface of a computing device.

In some embodiments, determining the at least one predicted resource unit development link comprises the program code being further configured to, with the at least one processor, further cause the apparatus to perform a resource unit development refinement operation.

In some embodiments, performing a resource unit development refinement operation comprises the program code being further configured to, with the at least one processor, further cause the apparatus to access external enterprise resource operations data. In some embodiments, performing a resource unit development refinement operation comprises the program code being further configured to, with the at least one processor, further cause the apparatus to parse the external enterprise resource operations data to identify at least a portion of the plurality of resource unit development items. In some embodiments, performing a resource unit development refinement operation comprises the program code being further configured to, with the at least one processor, further cause the apparatus to determine a resource unit development configuration structure associated with one or more of the plurality of resource unit development items. In some embodiments, performing a resource unit development refinement operation comprises the program code being further configured to, with the at least one processor, further cause the apparatus to determine the at least one predicted resource unit development link based at least in part on the resource unit development configuration structure.

In some embodiments, the at least one predicted resource unit development link is determined using a resource unit development link prediction model.

In some embodiments, the resource development generation interface component is generated based at least in part on an operations resource generation query.

In some embodiments, the plurality of resource unit development items comprises one or more of a resource unit development project identifier item, a resource unit development user identifier item, a resource unit development team identifier item, a resource unit development objective identifier item, a resource unit development milestone identifier item, a resource unit development allocation identifier item.

In some embodiments, the at least one memory and the program code are configured to, with the at least one processor, further cause the apparatus to identify a new explicit resource unit development link.

In some embodiments, the at least one memory and the program code are configured to, with the at least one processor, further cause the apparatus to generate an updated multi-dimensional refined resource unit development structure comprising the plurality of resource unit development items, the plurality of explicit resource unit development links, new explicit resource unit development link, the at least one predicted resource unit development link, and at least one new predicted resource unit development link.

In some embodiments, generating the updated multi-dimensional refined resource unit development structure comprises determining the at least one new predicted resource unit development link.

In some embodiments, the at least one memory and the program code are configured to, with the at least one processor, further cause the apparatus to identify a new resource unit development item.

In some embodiments, the at least one memory and the program code are configured to, with the at least one processor, further cause the apparatus to generate an updated multi-dimensional refined resource unit development structure comprising the plurality of resource unit development items, the new resource unit development item, the plurality of explicit resource unit development links, the at least one predicted resource unit development link, and at least one new predicted resource unit development link.

In some embodiments, generating the updated multi-dimensional refined resource unit development structure comprises determining the at least one new predicted resource unit development link.

In some embodiments, the at least one memory and the program code are configured to, with the at least one processor, further cause the apparatus to cause one or more resource development unit implementation allocations based at least in part on the updated multi-dimensional refined resource unit development structure.

In some embodiments, the at least one memory and the program code are configured to, with the at least one processor, further cause the apparatus to modify one or more resource development unit access permissions based at least in part on the updated multi-dimensional refined resource unit development structure.

In some embodiments, the at least one memory and the program code are configured to, with the at least one processor, further cause the apparatus to transmit one or more resource development unit action notifications based at least in part on the updated multi-dimensional refined resource unit development structure.

In some embodiments, the at least one memory and the program code are configured to, with the at least one processor, further cause the apparatus to generate, based at least in part on the multi-dimensional refined resource unit development structure, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component.

In accordance with another exemplary embodiment of the present disclosure, a method for outputting a resource development generation interface component to a resource operational interface is provided. In some embodiments, the method includes accessing resource unit development data representative of a plurality of refinement candidate resource unit development structures. In some embodiments, one or more of the plurality of refinement candidate resource unit development structures comprise at least one of a plurality of resource unit development items and at least one of a plurality of explicit resource unit development links. In some embodiments, the method includes generating a multi-dimensional refined resource unit development structure comprising the plurality of resource unit development items, the plurality of explicit resource unit development links, and at least one predicted resource unit development link. In some embodiments, generating the multi-dimensional refined resource unit development structure comprises determining the at least one predicted resource unit development link. In some embodiments, the method includes generating a resource development generation interface component based at least in part on the multi-dimensional refined resource unit development structure. In some embodiments, the resource development generation interface component comprises at least one of the plurality of resource unit development items. In some embodiments, generating the resource development generation interface component comprises selecting the at least one of the plurality of resource unit development items based at least in part on the at least one predicted resource unit development link. In some embodiments, the method includes outputting the resource development generation interface component for rendering to a resource operational interface of a computing device.

In some embodiments, determining the at least one predicted resource unit development link comprises performing a resource unit development refinement operation.

In some embodiments, performing a resource unit development refinement operation comprises accessing external enterprise resource operations data. In some embodiments, performing a resource unit development refinement operation comprises parsing the external enterprise resource operations data to identify at least a portion of the plurality of resource unit development items. In some embodiments, performing a resource unit development refinement operation comprises determining a resource unit development configuration structure associated with one or more of the plurality of resource unit development items. In some embodiments, performing a resource unit development refinement operation comprises determining the at least one predicted resource unit development link based at least in part on the resource unit development configuration structure.

In some embodiments, the at least one predicted resource unit development link is determined using a resource unit development link prediction model.

In some embodiments, the resource development generation interface component is generated based at least in part on an operations resource generation query.

In some embodiments, the plurality of resource unit development items comprises one or more of a resource unit development project identifier item, a resource unit development user identifier item, a resource unit development team identifier item, a resource unit development objective identifier item, a resource unit development milestone identifier item, a resource unit development allocation identifier item.

In some embodiments, the method further includes identifying a new explicit resource unit development link.

In some embodiments, the method further includes generating an updated multi-dimensional refined resource unit development structure comprising the plurality of resource unit development items, the plurality of explicit resource unit development links, new explicit resource unit development link, the at least one predicted resource unit development link, and at least one new predicted resource unit development link.

In some embodiments, generating the updated multi-dimensional refined resource unit development structure comprises determining the at least one new predicted resource unit development link.

In some embodiments, the method further includes identifying a new resource unit development item.

In some embodiments, the method further includes generating an updated multi-dimensional refined resource unit development structure comprising the plurality of resource unit development items, the new resource unit development item, the plurality of explicit resource unit development links, the at least one predicted resource unit development link, and at least one new predicted resource unit development link.

In some embodiments, generating the updated multi-dimensional refined resource unit development structure comprises determining the at least one new predicted resource unit development link.

In some embodiments, the method further includes causing one or more resource development unit implementation allocations based at least in part on the updated multi-dimensional refined resource unit development structure.

In some embodiments, the method further includes modifying one or more resource development unit access permissions based at least in part on the updated multi-dimensional refined resource unit development structure.

In some embodiments, the method further includes transmitting one or more resource development unit action notifications based at least in part on the updated multi-dimensional refined resource unit development structure.

In some embodiments, the method further includes generating, based at least in part on the multi-dimensional refined resource unit development structure, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component.

In accordance with another exemplary embodiment of the present disclosure, a computer program product for outputting a resource development generation interface component to a resource operational interface is provided. In some embodiments, the computer program product comprises at least one non-transitory computer-readable storage medium having computer-readable program code portions stored therein, the computer-readable program code portions comprising an executable portion. In some embodiments, the computer-readable program code portions comprising an executable portion are configured to access resource unit development data representative of a plurality of refinement candidate resource unit development structures. In some embodiments, one or more of the plurality of refinement candidate resource unit development structures comprise at least one of a plurality of resource unit development items and at least one of a plurality of explicit resource unit development links. In some embodiments, the computer-readable program code portions comprising an executable portion are configured to generate a multi-dimensional refined resource unit development structure comprising the plurality of resource unit development items, the plurality of explicit resource unit development links, and at least one predicted resource unit development link. In some embodiments, generating the multi-dimensional refined resource unit development structure comprises determining the at least one predicted resource unit development link. In some embodiments, the computer-readable program code portions comprising an executable portion are configured to generate a resource development generation interface component based at least in part on the multi-dimensional refined resource unit development structure. In some embodiments, the resource development generation interface component comprises at least one of the plurality of resource unit development items. In some embodiments, generating the resource development generation interface component comprises selecting the at least one of the plurality of resource unit development items based at least in part on the at least one predicted resource unit development link. In some embodiments, the computer-readable program code portions comprising an executable portion are configured to output the resource development generation interface component for rendering to a resource operational interface of a computing device.

In some embodiments, determining the at least one predicted resource unit development link comprises the computer-readable program code portions comprising an executable portion are further configured to perform a resource unit development refinement operation.

In some embodiments, performing a resource unit development refinement operation comprises the computer-readable program code portions comprising an executable portion are further configured to access external enterprise resource operations data. In some embodiments, performing a resource unit development refinement operation comprises the computer-readable program code portions comprising an executable portion are further configured to parse the external enterprise resource operations data to identify at least a portion of the plurality of resource unit development items. In some embodiments, performing a resource unit development refinement operation comprises the computer-readable program code portions comprising an executable portion are further configured to determine a resource unit development configuration structure associated with one or more of the plurality of resource unit development items. In some embodiments, performing a resource unit development refinement operation comprises the computer-readable program code portions comprising an executable portion are further configured to determine the at least one predicted resource unit development link based at least in part on the resource unit development configuration structure.

In some embodiments, the at least one predicted resource unit development link is determined using a resource unit development link prediction model.

In some embodiments, the resource development generation interface component is generated based at least in part on an operations resource generation query.

In some embodiments, the plurality of resource unit development items comprises one or more of a resource unit development project identifier item, a resource unit development user identifier item, a resource unit development team identifier item, a resource unit development objective identifier item, a resource unit development milestone identifier item, a resource unit development allocation identifier item.

In some embodiments, the computer-readable program code portions comprising an executable portion are further configured to identify a new explicit resource unit development link.

In some embodiments, the computer-readable program code portions comprising an executable portion are further configured to generate an updated multi-dimensional refined resource unit development structure comprising the plurality of resource unit development items, the plurality of explicit resource unit development links, new explicit resource unit development link, the at least one predicted resource unit development link, and at least one new predicted resource unit development link.

In some embodiments, generating the updated multi-dimensional refined resource unit development structure comprises determining the at least one new predicted resource unit development link.

In some embodiments, the computer-readable program code portions comprising an executable portion are further configured to identify a new resource unit development item.

In some embodiments, the computer-readable program code portions comprising an executable portion are further configured to generate an updated multi-dimensional refined resource unit development structure comprising the plurality of resource unit development items, the new resource unit development item, the plurality of explicit resource unit development links, the at least one predicted resource unit development link, and at least one new predicted resource unit development link.

In some embodiments, generating the updated multi-dimensional refined resource unit development structure comprises determining the at least one new predicted resource unit development link.

In some embodiments, the computer-readable program code portions comprising an executable portion are further configured to cause one or more resource development unit implementation allocations based at least in part on the updated multi-dimensional refined resource unit development structure.

In some embodiments, the computer-readable program code portions comprising an executable portion are further configured to modify one or more resource development unit access permissions based at least in part on the updated multi-dimensional refined resource unit development structure.

In some embodiments, the computer-readable program code portions comprising an executable portion are further configured to transmit one or more resource development unit action notifications based at least in part on the updated multi-dimensional refined resource unit development structure.

In some embodiments, the computer-readable program code portions comprising an executable portion are further configured to generate, based at least in part on the multi-dimensional refined resource unit development structure, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example resource unit development operation system configured to communicate with various client devices in accordance with various example embodiments of the present disclosure;

FIG. 2 depicts a schematic block diagram of example circuitry to perform various operations in accordance with various example embodiments of the present disclosure;

FIG. 3 illustrates example visualizations of refinement candidate resource unit development structures in accordance with various example embodiments of the present disclosure;

FIG. 4 illustrates an example visualization of a multi-dimensional refined resource unit development structure in accordance with various example embodiments of the present disclosure;

FIG. 5 illustrates another example visualization of a multi-dimensional refined resource unit development structure in accordance with various example embodiments of the present disclosure;

FIG. 6 illustrates another example visualization of a multi-dimensional refined resource unit development structure in accordance with various example embodiments of the present disclosure;

FIG. 7 illustrates an example resource development generation interface component in accordance with various example embodiments of the present disclosure;

FIG. 8 illustrates an example resource development individual generation interface component in accordance with various example embodiments of the present disclosure;

FIG. 9 illustrates an example resource development enterprise communication generation interface component in accordance with various example embodiments of the present disclosure;

FIG. 10 illustrates an example resource development team communication generation interface component in accordance with various example embodiments of the present disclosure;

FIG. 11 illustrates an example resource development summary generation interface component in accordance with various example embodiments of the present disclosure;

FIG. 12 illustrates an example resource development aggregated impact interface component in accordance with various example embodiments of the present disclosure;

FIG. 13 illustrates an example resource development impact interface component in accordance with various example embodiments of the present disclosure;

FIG. 14 illustrates an example resource development aggregated implementation interface component in accordance with various example embodiments of the present disclosure;

FIG. 15 illustrates an example resource development implementation interface component in accordance with various example embodiments of the present disclosure;

FIG. 16 depicts a flowchart diagram illustrating example operations for outputting a resource development generation interface component in accordance with an example embodiment of the present disclosure;

FIG. 17 depicts a flowchart diagram illustrating example operations for performing a resource unit development refinement operation in accordance with an example embodiment of the present disclosure;

FIG. 18 depicts a flowchart diagram illustrating example operations for generating an updated multi-dimensional refined resource unit development structure in accordance with an example embodiment of the present disclosure; and

FIG. 19 depicts flowchart diagram illustrating example operations for generating an updated multi-dimensional refined resource unit development structure in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to address technical problems associated with enabling efficient, reliable, and secure generation and provisioning of various interface components, such as a resource development generation interface component, based at least in part on a multi-dimensional refined resource unit development structure. This reduces computational load, provides a low latency user experience, and ensures secure access control of sensitive information.

A resource unit development operation system (e.g., Jira® by Atlassian) enables enterprises to plan track, organize, schedule, address, repair, diagnose, execute, modify, transmit, and/or otherwise manage complex and cross functional enterprise operations. In an agile resource unit development operation environment, it is desirable for a resource unit development operation system to leverage refinement candidate resource unit development structures comprised of resource unit development items (e.g., projects, teams, users, milestones, objectives, allocations, etc.) and explicit resource unit development links (e.g., links between projects, teams, users, milestones, objectives, allocations etc.) in order to enable such enterprise operations. For example, in agile resource unit development operation environments it is desirable to obtain complex and comprehensive mapping of resource unit development items and explicit resource unit development links in independent refinement candidate resource unit development structures in order to enable efficient, dynamic, and reliable enterprise operations. However, many refinement candidate resource unit development structures are associated with non-agile environments and, as a result, are simplistic and lack interoperability. This limits the ability of resource unit development operation systems in agile resource unit development operation environments to use refinement candidate resource unit development structures in order to enable complex and cross functional enterprise operations. As a result, it has become increasingly difficult for resource unit development operation systems to efficiently, dynamically, and reliably enable enterprise operations in agile resource unit development operation environments.

In some example resource unit development operation environments, it is not possible to dynamically implement various enterprise operations because an enterprise operation may depend on multiple independent and siloed refinement candidate resource unit development structures that lack interoperability (e.g., resource unit development items, such as projects or teams, may be associated with independent and siloed systems such that related resource unit development items cannot be linked). In some example, resource unit development operation environments it is not possible to automatically implement enterprise actions because refinement candidate resource unit development structures lack the necessary configurations and relationships to enable automatic enterprise actions, which is inefficient. In some example, resource unit development operation environments refinement candidate resource unit development structures are unable to be continuously and automatically be updated based on rapidly evolving enterprise information (e.g., when a new resource unit development item created, such as a new project, it is not possible to automatically link the new resource unit development item to preexisting resource unit development item, such as a preexisting team, that is associated with the new resource unit development item). As a result, enterprise operations cannot be implemented in reliable manner in many resource unit development operation environments because the necessary refinement candidate resource unit development structures may be out of date and/or include incorrect enterprise information.

In order to address these technical challenges, the inventors have determined that it is desirable to generate a multi-dimensional refined resource unit development structure and associated interface components. The multi-dimensional refined resource unit development structure may include resource unit development items and explicit resource unit development links (e.g., based on refinement candidate resource unit development structures) as well as predicted resource unit development links. As a result, the multi-dimensional refined resource unit development structure enables the dynamic implementation of enterprise operations in resource unit development operation environments by providing interoperability between independent and siloed refinement candidate resource unit development structures (e.g., between independent and siloed resource unit development items, such as projects or teams) through the generation of predicted resource unit development links.

In order to address these technical challenges, the inventors have also determined that it is desirable to enable automatic implementation of enterprise actions using a multi-dimensional refined resource unit development structure. For example, the multi-dimensional refined resource unit development structure may enable causing of one or more resource development unit implementation allocations, modifying of one or more resource development unit access permissions, and/or transmitting of one or more resource development unit action notifications. Thus, increasing efficiency in resource unit development operation environments through the provision of a multi-dimensional refined resource unit development structure that enables implementation of enterprise actions in resource unit development operation environments.

In order to address these technical challenges, the inventors have also determined that it is desirable to enable regular and accurate updating of the multi-dimensional refined resource unit development structure. For example, the multi-dimensional refined resource unit development structure may be updated based on newly identified explicit resource unit development links, newly identified resource unit development items (e.g., projects, teams, users, milestones, objectives, allocations, etc.), and/or newly generated predicted resource unit development links corresponding to new or modified enterprise operations in resource unit development environments. Thus, increasing the reliability of implementing enterprise operations in resource unit development environments. These characteristics as well as additional features, functions, and details are described below. Similarly, corresponding and additional embodiments are also described below.

### Definitions

The following explanations of terms are provided to better describe the present disclosure and to guide those of ordinary skill in the art in the practice of the present disclosure.

As used herein, the term “resource unit development operation system” refers to the software platform(s) and associated hardware configured to support and maintain a plurality of projects, workflows, and all associated functionality. For example, a resource unit development operation system may comprise a software product such as Jira® by Atlassian®. Example resource unit development operation systems comprise supporting server(s) and repositor(ies), and in some embodiments, are further configured to engage with internal resources, external resources, internal applications, and/or external applications.

As used herein, the term “resource unit development operation server” refers to a software platform and associated hardware that is configured to, inter alia, manage the various interfaces and/or interface components and associated functionality of the resource unit development operation system. For example, in some embodiments, the resource unit development operation server is configured to generate, manage, output, and/or update resource operational interfaces, resource development generation interface components, resource development individual generation interface components, resource development enterprise communication generation interface components, resource development group communication generation interface components, resource development summary generation interface components, resource development aggregated impact interface components, resource development impact interface components, resource development aggregated implementation interface components, or resource development implementation interface components.

As another example, in some embodiments, the resource unit development operation server is configured to identify, determine, generate, and/or output resource unit development data, external enterprise resource operations data, resource unit development items, explicit resource unit development links, predicted resource unit development links, refinement candidate resource unit development structures, multi-dimensional refined resource unit development structures, and/or resource unit development configuration structures.

As another example, in some embodiments, the resource unit development operation server is configured to generate, perform, and/or implement resource unit development refinement operations. As another example, in some embodiments, the resource unit development operation server is configured to generate, trigger, cause, modify, and/or transmit resource development unit access permissions, resource development unit action notifications, and/or resource development unit implementation allocations.

As another example, in some embodiments, the resource unit development operation server is configurated to generate, train, and/or refine resource unit development link prediction models, trained machine learning models, rules-based models, and/or statistical models. The functionality of the resource unit development operation server may be provided via a single server or collection of servers having a common functionality, or the functionality of the resource unit development operation server may be segmented among a plurality of servers or collections of servers (e.g., a cloud networking environment, microservices, and/or the like) performing subsets of the described functionality of the resource unit development operation server.

As used herein, the term “resource unit development data repository” refers to a location, such as a database stored on a memory device, which is accessible by one or more computing devices for retrieval and storage of data associated with the resource unit development operation system. For example, the resource unit development data repository may include resource unit development data resource unit development items, explicit resource unit development links, and/or refinement candidate resource unit development structures. The resource unit development data repository may be a dedicated device and/or part of a larger repository. The resource unit development data repository may be dynamically updated or be static. In some embodiments, the resource unit development data repository is encrypted in order to limit unauthorized access of data associated with the resource unit development operation system.

As used herein, the term “multi-dimensional refined resource unit development structure data repository” refers to a location, such as a database stored on a memory device, which is accessible by one or more computing devices for retrieval and storage of data associated with the resource unit development operation system. For example, the multi-dimensional refined resource unit development structure data repository may include predicted resource unit development links and/or multi-dimensional refined resource unit development structures. The multi-dimensional refined resource unit development structure data repository may be a dedicated device and/or part of a larger repository. The multi-dimensional refined resource unit development structure data repository may be dynamically updated or be static. In some embodiments, the multi-dimensional refined resource unit development structure data repository is encrypted in order to limit unauthorized access of data associated with the resource unit development operation system.

As used herein, the term “external enterprise resource operations data repository” refers to a location, such as a database stored on a memory device, which is accessible by one or more computing devices for retrieval and storage of data associated with the resource unit development operation system. For example, the external enterprise resource operations data repository may include external enterprise resource operations data and/or resource unit development configuration structures. The external enterprise resource operations data repository may be a dedicated device and/or part of a larger repository. The external enterprise resource operations data repository may be dynamically updated or be static. In some embodiments, the external enterprise resource operations data repository is encrypted in order to limit unauthorized access of data associated with the resource unit development operation system.

As used herein, the terms “resource unit development operation application” or “resource unit development operation app” refer to a dedicated software program, application, platform, service, web browser, or computer-executable application software programmed or configured to run on a client device which provides a user access to the resource unit development operation system and its associated functionality. In some embodiments, the resource unit development operation application may include hardware, software, or combinations thereof operating remotely (e.g., on a server). In some embodiments, the resource unit development operation application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

As used herein, the term “resource unit development data” refers to one or more items of data indicative and/or representative of one or more refinement candidate resource unit development structures. For example, the resource unit development data may be one or more items of data indicative and/or representative of one or more resource unit development items and/or one or more explicit resource unit development links. In some embodiments, the resource unit development data may be stored in a resource unit development repository.

As used herein, the term “refinement candidate resource unit development structure” refers to a domain-specific data structure of an aggregation of resource unit development items and/or a domain-specific data structure of an aggregation of explicit resource unit development links configured in an at least partially ordered structure in a resource unit development operation system. In some embodiments, a refinement candidate resource unit development structure may be associated with one or more unrefined links, unrefined connections, unrefined relationships, unrefined associations, unrefined bonds, and/or the like between one or more of the resource unit development items in the refinement candidate resource unit development structure and/or one or more other resource unit development items.

As used herein, the term “resource unit development item” refers to a data object that is representative of and/or associated with a project, a user, a team, an objective, a milestone, and/or an allocation. For example, a resource unit development item may include or correspond to a resource unit development project identifier item, resource unit development user identifier item, resource unit development team identifier item, resource unit development objective identifier item, resource unit development milestone identifier item, and/or a resource unit development allocation identifier item.

As used herein, the term “resource unit development user identifier item” refers to a data object that is representative of and/or associated with a user, such as an individual contributor, team member, team leader, etc. in a resource unit development operation system. In some embodiments, a resource unit development user identifier item may uniquely identify a user in a resource unit development operation system. In some embodiments, a resource unit development user identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “resource unit development team identifier item” refers to a data object that is representative of and/or associated with a structured group of associated users (e.g., a team) in a resource unit development operation system. In some embodiments a resource unit development team identifier item may uniquely identify a structured group of associated users in a resource unit development operation system. In some embodiments, a resource unit development team identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “resource unit development project identifier item” refers to a data object that is representative of and/or associated with a collection of actionable items, work items, issue resolutions, and/or the like that correspond to tasks to be completed in a project development life cycle, such as a software project development life cycle, associated with a resource unit development operation system. For example, an actionable item may represent an individual task, such as a software development task, which is to be completed in a software project development life cycle. In some embodiments, a resource unit development project identifier item may uniquely identify a collection of actionable items, work items, issue resolutions, and/or the like that correspond to tasks to be completed in a project development life cycle in a resource unit development operation system. In some embodiments, a resource unit development project identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “resource unit development objective identifier item” refers to a data object that is representative of and/or associated a user goal, a user objective, a team goal, a team objective, an enterprise goal, an enterprise objective, and/or the like associated with a resource unit development operation system. For example, a resource unit development objective identifier item may be a data object that is representative of and/or associated with an enterprise goal of implementing a digital transformation in a defined time period. In some embodiments, a resource unit development objective identifier item may uniquely identify a user goal, user objective, team goal, team objective, enterprise goal, enterprise objective in a resource unit development operation system. In some embodiments, a resource unit development objective identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “resource unit development milestone identifier item” refers to a data object that is representative of and/or associated with an intermediate user goal, an intermediate user objective, an intermediate team goal, an intermediate team objective, an intermediate enterprise goal, an intermediate enterprise objective that represents a phase, portion, halfway point, and/or the like of a user goal, a user objective, a team goal, a team objective, an enterprise goal, an enterprise objective, and/or the like associated with a resource unit development operation system. For example, a resource unit development milestone identifier item may be a data object that is representative of and/or associated with an intermediate enterprise goal of implementing a digital transformation in a defined time period (e.g., implement half of the digital transformation by the halfway point of the defined time period). In some embodiments, a resource unit development milestone identifier may uniquely identify a an intermediate user goal, an intermediate user objective, an intermediate team goal, an intermediate team objective, an intermediate enterprise goal, an intermediate enterprise objective that represents a phase, portion, halfway point, and/or the like of a user goal, a user objective, a team goal, a team objective, an enterprise goal, an enterprise objective in a resource unit development operation system. In some embodiments, a resource unit development milestone identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “resource unit development allocation identifier item” refers to a data object that is representative of and/or associated with a resource, allocation, tool, items, and/or the like that are needed and/or used by a user and/or structured group of associated users to complete a collection of actionable items, complete a collection of work items, complete a collection of issue resolutions, reach a milestone, and/or accomplish an objective associated with a resource unit development operation system. In some embodiments, a resource unit development allocation identifier item may uniquely identify a resource, allocation, tool, item, and/or the like that are needed and/or used by a user and/or structured group of associated users to complete a collection of actionable items, complete a collection of work items, complete a collection of issue resolutions, reach a milestone, and/or accomplish an objective in a resource unit development operation system. In some embodiments, a resource unit development project identifier item may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “enterprise” refers to one or more data objects by which a set of users are associated with a particular entity (e.g., employees or contractors of different companies may be of separate enterprises). As used herein, the term “enterprise identifier” refers to a data object by which an enterprise may be uniquely identified in a resource unit development operation system. For example, an enterprise identifier data object may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

As used herein, the term “explicit resource unit development link” refers to a data object representative of and/or associated with a link, connection, relationship, association, bond, and/or the like between one or more resource unit development items that was defined at the generation of the one or more resource unit development items. In some embodiments, an explicit resource unit development link may be a data object representative of and/or associated with a link, connection, relationship, association, bond, and/or the like between one or more resource unit development items that are in the same refinement candidate resource unit development structure. For example, an explicit resource unit development link may be data object representative of and/or associated with a link, connection, relationship, association, bond, and/or the like between a first resource unit development item associated with a first refinement candidate resource unit development structure and a second resource unit development item associated with the first refinement candidate resource unit development structure.

In some embodiments, for example, an explicit resource unit development link may be a data object representative of and/or associated with a link, connection, relationship, association, bond, and/or the like between a resource unit development user identifier item and a resource unit development team identifier item that was defined at the generation of the resource unit development user identifier item and/or the resource unit development team identifier item. As another example, an explicit resource unit development link may be a data object representative of and/or associated with a link, connection, relationship, association, bond, and/or the like between a resource unit development team identifier item and a resource unit development project identifier item that was defined at the generation of the resource unit development project identifier item and/or the resource unit development team identifier item. As another example, an explicit resource unit development link may be a data object representative of and/or associated with a link, connection, relationship, association, bond, and/or the like between a resource unit development objective identifier item and a resource unit development milestone identifier item that was defined at the generation of the resource unit development objective identifier item and/or the resource unit development milestone identifier item. As another example, an explicit resource unit development link may be a data object representative of and/or associated with a link, connection, relationship, association, bond, and/or the like between a resource unit development allocation identifier item and a resource unit development project identifier item that was defined at the generation of the resource unit development allocation identifier item and/or the resource unit development project identifier item.

As used herein, the term “multi-dimensional refined resource unit development structure” refers to a domain-specific data structure of an aggregation of resource unit development items, a domain-specific data structure of an aggregation of predicted resource unit development links, and/or a domain-specific data structure of an aggregation of explicit resource unit development links configured in an at least partially ordered structure in a resource unit development operation system.

As used herein, the term “predicted resource unit development link” refers to a data object representative of and/or associated with a link, connection, relationship, association, bond, and/or the like between one or more resource unit development items that is generated by a resource unit development operation system using a resource unit development link prediction model.

In some embodiments, a predicted resource unit development link may be data object representative of and/or associated with a link, connection, relationship, association, bond, and/or the like between one or more resource unit development items that are associated with the same refinement candidate resource unit development structure. For example, a predicted resource unit development link may be data object representative of and/or associated with a link, connection, relationship, association, bond, and/or the like between one or more resource unit development items that are in the same refinement candidate resource unit development structure that are not linked, connected, bonded, associated with, and/or the like by an explicit resource unit development link. In some embodiments, a predicted resource unit development link may be data object representative of and/or associated with a link, connection, relationship, association, bond, and/or the like between one or more resource unit development items that are not associated with the same refinement candidate resource unit development structure. For example, a predicted resource unit development link may be data object representative of and/or associated with a link, connection, relationship, association, bond, and/or the like between a first resource unit development item associated with a first refinement candidate resource unit development structure and a second resource unit development item associated with a second refinement candidate resource unit development structure.

In some embodiments, for example, a predicted resource unit development link may be a data object representative of and/or associated with a link, connection, relationship, association, bond, and/or the like between a resource unit development user identifier item and a resource unit development team identifier item that is generated by a resource unit development operation system using a resource unit development link prediction model. As another example, a predicted resource unit development link may be a data object representative of and/or associated with a link, connection, relationship, association, bond, and/or the like between a resource unit development team identifier item and a resource unit development project identifier item that is generated by a resource unit development operation system using a resource unit development link prediction model. As another example, a predicted resource unit development link may be a data object representative of and/or associated with a link, connection, relationship, association, bond, and/or the like between a resource unit development objective identifier item and a resource unit development milestone identifier item that is generated by a resource unit development operation system using a resource unit development link prediction model. As another example, a predicted resource unit development link may be a data object representative of and/or associated with a link, connection, relationship, association, bond, and/or the like between a resource unit development allocation identifier item and a resource unit development project identifier item that is generated by a resource unit development operation system using a resource unit development link prediction model.

As used herein, the term “resource unit development refinement operation” refers to a data object that provides refinement commands, refinement directives, and/or refinement specifications for conducting refinement operations to generate one or more predicted resource unit development links. In some embodiments, by providing refinement commands, refinement directives, and/or refinement specifications, a resource unit development refinement operation may be configured to access external enterprise resource operations data, parse external enterprise resource operations data to identify one or more resource unit development items, determine one or more resource unit development configuration structures associated with one or more of a plurality of resource unit development items, and determine one or more predicted resource unit development links based at least in part on the resource unit development configuration structure. In some embodiments, determining one or more resource unit development configuration structures may include assigning one or more weights to one or more of a plurality of resource unit development items and/or normalizing one or more of a plurality of resource unit development items.

As used herein, the term “external enterprise resource operations data” refers to one or more items of data indicative and/or representative of at least a portion of one or more resource unit development items. In some embodiments, the portion of one or more resource unit development items may be associated with an enterprise associated with a resource unit development operation system. For example, external enterprise resource operations data may be one or more items of data indicative and/or representative of one or more resource unit development user identifier items associated with an enterprise from one or more resource unit development items. In some embodiments, external enterprise resource operations data may be stored in an external enterprise resource operations data repository. In some embodiments, a resource unit development operation system may be configured to parse external enterprise resource operations data. In some embodiments, external enterprise resource operations data may include an update identifier configured to indicate when the external enterprise resource operations data was last updated.

As used herein, the term “resource unit development configuration structure” refers to a domain-specific data structure of an aggregation of at least a portion of one or more resource unit development items configured in an at least partially ordered structure in a resource unit development operation system. In some embodiments, the portion of one or more resource unit development items may be associated with an enterprise associated with a resource unit development operation system. For example, a resource unit development configuration structure may be a domain-specific data structure of an aggregation of one or more resource unit development user identifier items associated with an enterprise from one or more resource unit development items configured in an at least partially ordered structure in a resource unit development operation system. In some embodiments, a resource unit development operation system may be configured to determine a resource unit development configuration structure. In some embodiments, a resource unit development operation system may be configured to determine one or more predicted resource unit development links based at least in part on a resource unit development configuration structure.

As used herein, the term “resource unit development link prediction model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). In some embodiments, a resource unit development operation system may be configured to determine one or more predicted resource unit development links using a resource unit development link prediction model. In this regard, for example, a resource unit development operation system may be configured to at least in part perform a resource unit development refinement operation using a resource unit development link prediction model. In some embodiments, a resource unit development link prediction model may be trained using resource unit development data and/or external enterprise resource operations data.

As used herein, the term “resource operational interface” refers to a graphical user interface of a resource unit development operation system that is configured to enable one or more users to view and engage with one or more resource unit development operation system workspaces, views, and/or interface components. In some embodiments, for example, a resource operational interface is configured to enable one or more users to view and engage with one or more resource development generation interface components, resource development individual generation interface components, resource development enterprise communication generation interface components, resource development group communication generation interface components, resource development summary generation interface components, resource development aggregated impact interface components, resource development impact interface components, resource development aggregated implementation interface components, or resource development implementation interface components. In some embodiments, a resource operational interface may be rendered to a client device based on data provided by the resource unit development operation system (e.g., using a resource unit development operation server). In some embodiments, such data and instructions are facilitated by a dedicated software application running on the client device. In other embodiments, such data and instructions are provided through a web browser running on the client device.

As used herein, the term “resource development generation interface component” refers to a graphical user interface element that is rendered to or as a portion of, a resource operational interface of a resource unit development operation system. In some embodiments, a resource development generation interface component may be configured to display one or more resource unit development items. For example, a resource development generation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development generation interface component may be configured to display one or more resource unit development items associated with an enterprise associated with a resource unit development operation system. For example, a resource development generation interface component may be configured to display a resource unit development user identifier item associated with users of an enterprise associated with a resource unit development operation system. As another example, a resource development generation interface component may be configured to display a resource unit development team identifier item associated with teams of an enterprise associated with a resource unit development operation system. As another example, a resource development generation interface component may be configured to display a resource unit development project identifier item associated with projects of an enterprise associated with a resource unit development operation system. As another example, a resource development generation interface component may be configured to display a resource unit development milestone identifier item associated with milestones of an enterprise associated with a resource unit development operation system. As another example, a resource development generation interface component may be configured to display a resource unit development objective identifier item associated with objectives of an enterprise associated with a resource unit development operation system.

In some embodiments, a resource development generation interface component may be generated based at least in part on a multi-dimensional refined resource unit development structure. In this regard, for example, a resource development generation interface component may be generated based at least in part on one or more resource unit development items, explicit resource unit development links, and/or predicted resource unit development links associated with a multi-dimensional refined resource unit development structure. Additionally, or alternatively, a resource development generation interface component may be generated based at least in part on an operations resource generation query.

As used herein, the term “resource development individual generation interface component” refers to a graphical user interface element that is rendered to or as a portion of, a resource operational interface of a resource unit development operation system. In some embodiments, a resource development individual generation interface component may be configured to display one or more resource unit development items. For example, a resource development individual generation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development individual generation interface component may be configured to display one or more resource unit development items associated with a user associated with a resource unit development operation system. For example, a resource development individual generation interface component may be configured to display a resource unit development objective identifier item associated with a user associated with a resource unit development operation system. As another example, a resource development individual generation interface component may be configured to display a resource unit development milestone identifier item associated with milestones of a user associated with a resource unit development operation system.

In some embodiments, a resource development individual generation interface component may be generated based at least in part on a multi-dimensional refined resource unit development structure. In this regard, for example, a resource development individual generation interface component may be generated based at least in part on one or more resource unit development items, explicit resource unit development links, and/or predicted resource unit development links associated with a multi-dimensional refined resource unit development structure. Additionally, or alternatively, a resource development individual generation interface component may be generated based at least in part on an operations resource generation query.

As used herein, the term “resource development enterprise communication generation interface component” refers to a graphical user interface element that is rendered to or as a portion of, a resource operational interface of a resource unit development operation system. In some embodiments, a resource development enterprise communication generation interface component may be configured to be displayed proximate to, overlaid on, and/or as a portion of a resource development generation interface component and/or another interface component of a resource unit development operation system. In some embodiments, a resource development enterprise communication generation interface component may be configured to display one or more resource unit development items. For example, a resource development enterprise communication generation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development enterprise communication generation interface component may be configured to display one or more resource unit development items associated with enterprise communications associated with a resource unit development operation system. For example, a resource development enterprise communication generation interface component may be configured to display a resource unit development team identifier item associated with communications related to one or more teams associated with an enterprise associated with a resource unit development operation system. As another example, a resource development enterprise communication generation interface component may be configured to display a resource unit development allocation identifier item associated with communications associated with allocations of an enterprise associated with a resource unit development operation system.

In some embodiments, a resource development enterprise communication generation interface component may be generated based at least in part on a multi-dimensional refined resource unit development structure. In this regard, for example, a resource development enterprise communication generation interface component may be generated based at least in part on one or more resource unit development items, explicit resource unit development links, and/or predicted resource unit development links associated with a multi-dimensional refined resource unit development structure. Additionally, or alternatively, a resource development enterprise communication generation interface component may be generated based at least in part on an operations resource generation query.

As used herein, the term “resource development team communication generation interface component” refers to a graphical user interface element that is rendered to or as a portion of, a resource operational interface of a resource unit development operation system. In some embodiments, a resource development team communication generation interface component may be configured to be displayed proximate to, overlaid on, and/or as a portion of another interface component of a resource unit development operation system. In some embodiments, a resource development team communication generation interface component may be configured to display one or more resource unit development items. For example, a resource development team communication generation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development team communication generation interface component may be configured to display one or more resource unit development items associated with communications of one or more teams associated with a resource unit development operation system. For example, a resource development team communication generation interface component may be configured to display a resource unit development team identifier item associated with a communication of one or more teams associated with a resource unit development operation system. As another example, a resource development team communication generation interface component may be configured to display a resource unit development project identifier item associated with communications associated with a project associated with a resource unit development operation system.

In some embodiments, a resource development team communication generation interface component may be generated based at least in part on a multi-dimensional refined resource unit development structure. In this regard, for example, a resource development team communication generation interface component may be generated based at least in part on one or more resource unit development items, explicit resource unit development links, and/or predicted resource unit development links associated with a multi-dimensional refined resource unit development structure. Additionally, or alternatively, a resource development team communication generation interface component may be generated based at least in part on an operations resource generation query.

As used herein, the term “resource development summary generation interface component” refers to a graphical user interface element that is rendered to or as a portion of, a resource operational interface of a resource unit development operation system. In some embodiments, a resource development team communication generation interface component may be configured to be displayed proximate to, overlaid on, and/or as a portion of another interface component of a resource unit development operation system. In some embodiments, a resource development summary generation interface component may be configured to display one or more resource unit development items. For example, a resource development summary generation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development summary generation interface component may be configured to display one or more resource unit development items associated with a summary of one or more resource unit development items associated with a resource unit development operation system. For example, a resource development summary generation interface component may be configured to display a resource unit development milestone identifier item associated with a summary of a milestone associated with a resource unit development operation system. As another example, a resource development summary generation interface component may be configured to display a resource unit development objective identifier item associated with a summary of an objective associated with a resource unit development operation system.

In some embodiments, a resource development summary generation interface component may be generated based at least in part on a multi-dimensional refined resource unit development structure. In this regard, for example, a resource development summary generation interface component may be generated based at least in part on one or more resource unit development items, explicit resource unit development links, and/or predicted resource unit development links associated with a multi-dimensional refined resource unit development structure. Additionally, or alternatively, a resource development summary generation interface component may be generated based at least in part on an operations resource generation query.

As used herein, the term “resource development aggregated impact interface component” refers to a graphical user interface element that is rendered to or as a portion of, a resource operational interface of a resource unit development operation system. In some embodiments, a resource development aggregated impact interface component may be configured to display one or more resource unit development items. For example, a resource development aggregated impact interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development aggregated impact interface component may be configured to display one or more resource unit development items associated with an aggregated list of resource unit development items associated with a resource unit development operation system. For example, a resource development aggregated impact interface component may be configured to display a resource unit development objective identifier item associated with an aggregated list of resource unit development objective identifier items associated with a resource unit development operation system. As another example, a resource development aggregated impact interface component may be configured to display a resource unit development milestone identifier item associated with an aggregated list of resource unit development milestone identifier items associated with a resource unit development operation system. As another example, a resource development aggregated impact interface component may be configured to display a resource unit development team identifier item associated with an aggregated list of resource unit development team identifier items associated with a resource unit development operation system. As another example, a resource development aggregated impact interface component may be configured to display a resource unit development allocation identifier item associated with an aggregated list of resource unit development allocation identifier items associated with a resource unit development operation system. As another example, a resource development aggregated impact interface component may be configured to display a resource unit development project identifier item associated with an aggregated list of resource unit development project identifier items associated with a resource unit development operation system. As another example, a resource development aggregated impact interface component may be configured to display a resource unit development user identifier item associated with an aggregated list of resource unit development user identifier items associated with a resource unit development operation system.

In some embodiments, a resource development aggregated impact interface component may be generated based at least in part on a multi-dimensional refined resource unit development structure. In this regard, for example, a resource development aggregated impact interface component may be generated based at least in part on one or more resource unit development items, explicit resource unit development links, and/or predicted resource unit development links associated with a multi-dimensional refined resource unit development structure. Additionally, or alternatively, a resource development aggregated impact interface component may be generated based at least in part on an operations resource generation query.

As used herein, the term “resource development impact interface component” refers to a graphical user interface element that is rendered to or as a portion of, a resource operational interface of a resource unit development operation system. In some embodiments, a resource development impact interface component may be configured to display one or more resource unit development items. For example, a resource development impact interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development impact interface component may be configured to display one or more resource unit development items associated with an impact associated with a resource unit development operation system. For example, a resource development impact interface component may be configured to display a resource unit development milestone identifier item associated with the impact of a milestone associated with a resource unit development operation system. As another example, a resource development impact interface component may be configured to display a resource unit development team identifier item associated with the impact of a team associated with a resource unit development operation system. As another example, a resource development impact interface component may be configured to display a resource unit development allocation identifier item associated with the impact of an allocation associated with a resource unit development operation system. As another example, a resource development impact interface component may be configured to display a resource unit development project identifier item associated with the impact of a project associated with a resource unit development operation system. As another example, a resource development impact interface component may be configured to display a resource unit development objective identifier item associated with the impact of an objective associated with a resource unit development operation system.

In some embodiments, a resource development impact interface component may be generated based at least in part on a multi-dimensional refined resource unit development structure. In this regard, for example, a resource development impact interface component may be generated based at least in part on one or more resource unit development items, explicit resource unit development links, and/or predicted resource unit development links associated with a multi-dimensional refined resource unit development structure. Additionally, or alternatively, a resource development impact interface component may be generated based at least in part on an operations resource generation query.

As used herein, the term “resource development aggregated implementation interface component” refers to a graphical user interface element that is rendered to or as a portion of, a resource operational interface of a resource unit development operation system. In some embodiments, a resource development aggregated implementation interface component may be configured to be displayed proximate to, overlaid on, and/or as a portion of a resource development generation interface component and/or another interface component of a resource unit development operation system. In some embodiments, a resource development aggregated implementation interface component may be configured to display one or more resource unit development items. For example, a resource development aggregated implementation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development aggregated implementation interface component may be configured to display an aggregated list of resource unit development items associated with a resource unit development operation system that have been implemented. For example, a resource development aggregated implementation interface component may be configured to display a resource unit development project identifier item associated with an aggregated group of projects associated with a resource unit development operation system that has been implemented.

In some embodiments, a resource development aggregated implementation interface component may be generated based at least in part on a multi-dimensional refined resource unit development structure. In this regard, for example, a resource development aggregated implementation interface component may be generated based at least in part on one or more resource unit development items, explicit resource unit development links, and/or predicted resource unit development links associated with a multi-dimensional refined resource unit development structure. Additionally, or alternatively, a resource development aggregated implementation interface component may be generated based at least in part on an operations resource generation query.

As used herein, the term “resource development implementation interface component” refers to a graphical user interface element that is rendered to or as a portion of, a resource operational interface of a resource unit development operation system. In some embodiments, a resource development implementation interface component may be configured to display one or more resource unit development items. For example, a resource development implementation interface component may be configured to display one or more of a resource unit development user identifier item, a resource unit team identifier item, a resource unit development project identifier item, a resource unit development milestone identifier item, and/or a resource unit development allocation identifier item.

In some embodiments, a resource development implementation interface component may be configured to display one or more resource unit development items associated with a resource unit development operation system that have been implemented. For example, a resource development implementation interface component may be configured to display a resource unit development user identifier item associated with a user associated with a resource unit development operation system that has been implemented. As another example, a resource development implementation interface component may be configured to display a resource unit development team identifier item associated with a team associated with a resource unit development operation system that has been implemented. As another example, a resource development implementation interface component may be configured to display a resource unit development objective identifier item associated with an objective associated with a resource unit development operation system that has been implemented. As another example, a resource development implementation interface component may be configured to display a resource unit development milestone identifier item associated with a milestone associated with a resource unit development operation system that has been implemented. As another example, a resource development implementation interface component may be configured to display a resource unit development allocation identifier item associated with an allocation associated with a resource unit development operation system that has been implemented.

In some embodiments, a resource development implementation interface component may be generated based at least in part on a multi-dimensional refined resource unit development structure. In this regard, for example, a resource development implementation interface component may be generated based at least in part on one or more resource unit development items, explicit resource unit development links, and/or predicted resource unit development links associated with a multi-dimensional refined resource unit development structure. Additionally, or alternatively, a resource development implementation interface component may be generated based at least in part on an operations resource generation query.

As used herein, the term “operations resource generation query” refers to a query for data objects, digital content items, data items, interface components, and/or interfaces submitted to the resource unit development operation system.

As used herein, the term “resource development unit implementation allocation” refers to a data object representative of and/or associated with an action performed by a resource unit development operation system that includes causing allocation of resources, allocations, tools, data, items, and/or the like. In some embodiments, a resource development unit implementation allocation may be based at least in part on a multi-dimensional refined resource unit development structure. In some embodiments, a resource development unit implementation allocation may be based at least in part on a multi-dimensional refined resource unit development structure. In this regard, a resource development unit implementation allocation may be caused based at least in part on a resource unit development operation system generating an updated multi-dimensional refined resource unit development structure.

As used herein, the term “resource development unit access permission” refers to a data object representative of and/or associated with an action performed by a resource unit development operation system that includes modifying one or more access permissions associated with a multi-dimensional refined resource unit development structure. In some embodiments, a resource development unit access permission may be based at least in part on a multi-dimensional refined resource unit development structure. In some embodiments, a resource development unit access permission may be based at least in part on a multi-dimensional refined resource unit development structure. In this regard, a resource development unit access permission may be modified based at least in part on a resource unit development operation system generating an updated multi-dimensional refined resource unit development structure.

As used herein, the term “resource development unit action notification” refers to a data object representative of and/or associated with an action performed by a resource unit development operation system that includes transmitting a notification. In some embodiments, resource development unit action notification and/or an updated multi-dimensional refined resource unit development structure. In this regard, a resource development unit action notification may be modified based at least in part on a resource unit development operation system generating an updated multi-dimensional refined resource unit development structure.

As used herein, the term “new resource unit development item” refers to a data object representative of and/or associated with a new project, a new user, a new team, a new objective, a new milestone, and/or a new allocation. For example, a new resource unit development item may include or correspond to a new resource unit development project identifier item, new resource unit development user identifier item, new resource unit development team identifier item, new resource unit development objective identifier item, new resource unit development milestone identifier item, and/or a new resource unit development allocation identifier item. In some embodiments, a resource unit development operation system may be configured to identify a new resource unit development item. For example, a resource unit development operation system may be configured to identify a new resource unit development item based on an input provided to a resource unit development operation system. In some embodiments, a resource unit development operation system may be configured to generate an updated multi-dimensional refined resource unit development structure based at least in part on a new resource unit development item.

As used herein, the term “new explicit resource unit development link” refers to a data object representative of and/or associated with a new link, new connection, new relationship, new association, new bond, and/or the like between one or more new resource unit development items that was defined at the generation of the one or more new resource unit development items. In some embodiments, a new explicit resource unit development link may be a data object representative of and/or associated with a new link, new connection, new relationship, new association, new bond, and/or the like between one or more new resource unit development items that are in the same refinement candidate resource unit development structure. For example, a new explicit resource unit development link may be data object representative of and/or associated with a new link, new connection, new relationship, new association, new bond, and/or the like between a first new resource unit development item associated with a first refinement candidate resource unit development structure and a second new resource unit development item associated with the first refinement candidate resource unit development structure.

In some embodiments, a resource unit development operation system may be configured to identify a new explicit resource unit development link. For example, a resource unit development operation system may be configured to identify a new res explicit resource unit development link based on an input provided to a resource unit development operation system. In some embodiments, a resource unit development operation system may be configured to generate an updated multi-dimensional refined resource unit development structure based at least in part on a new explicit resource unit development link.

As used herein, the term “new predicted resource unit development link” refers to a data object representative of and/or associated with a new link, new connection, new relationship, new association, new bond, and/or the like between one or more new resource unit development items that is generated by a resource unit development operation system using a resource unit development link prediction model.

As used herein, the term “updated multi-dimensional refined resource unit development structure” refers to an updated domain-specific data structure of an aggregation of resource unit development items, a domain-specific data structure of an aggregation of new resource unit development items, a domain-specific data structure of an aggregation of predicted resource unit development links, a domain-specific data structure of an aggregation of new predicted resource unit development links, a domain-specific data structure of an aggregation of new explicit resource unit development links and/or a domain-specific data structure of an aggregation of explicit resource unit development links in a resource unit development operation system.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., resource unit development operation server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Example Systems and Apparatuses of the Disclosure

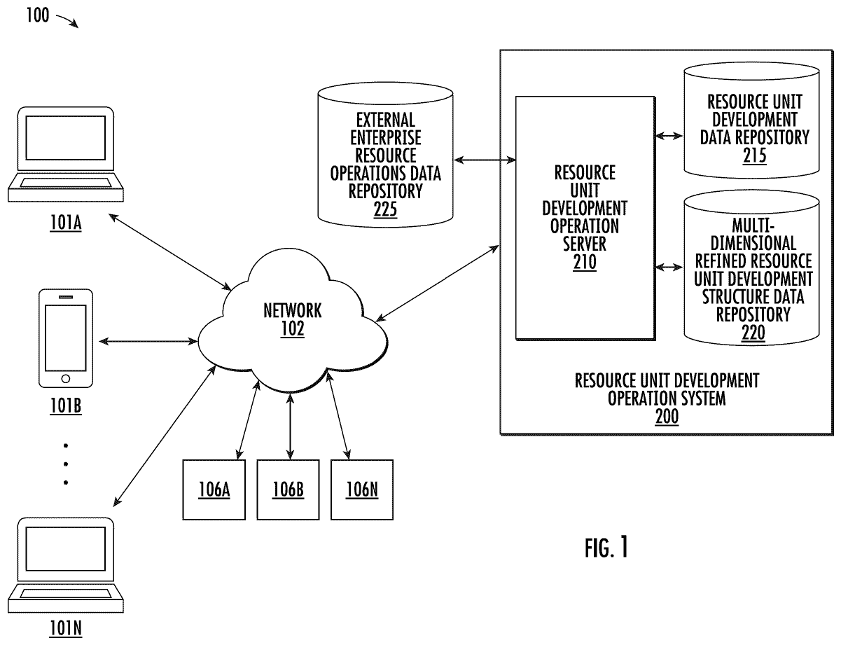

Referring now to FIG. 1, an example computing system 100 architecture within which some embodiments of the present disclosure operate is illustrated. The example computing system 100 comprises one or more software development tools 106A-106N, resource unit development operation system 200, and a plurality of client devices 101A-101N, each communicatively connected through a communications network 102. Accordingly, user(s) (e.g., team member, individual contributor, team leader, team member, designer, etc.) may access the resource unit development operation system 200 via the communications network 102 using one or more of client devices 101A-101N. Resource unit development operation system 200 may comprise an resource unit development operation server 210 in communication with at least one repository, such as a resource unit development data repository 215, the multi-dimensional refined resource unit development structure data repository 220, and/or an external enterprise resource operations data repository 225. Such repository(ies) may be hosted by the resource unit development operation server 210 or otherwise hosted by devices in communication with the resource unit development operation server 210.

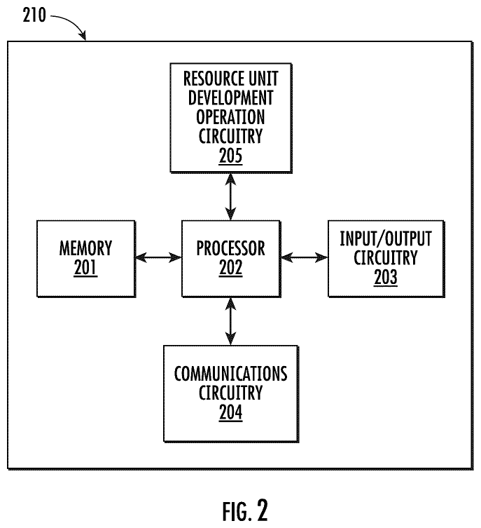

Resource unit development operation server 210 may include circuitry, networked processors, or the like configured to perform some or all of the resource unit development operation server-based processes described herein and may be any suitable network server and/or other type of processing device. In some embodiments, resource unit development operation server 210 may determine and transmit commands and instructions for rendering one or more resource operational interfaces to client devices 101A-101N, using data from, for example, the resource unit development data repository 215, the multi-dimensional refined resource unit development structure data repository 220, and/or the external enterprise resource operations data repository 225. In this regard, the resource unit development operation server 210 may be embodied by any of a variety of devices, for example, the resource unit development operation server 210 may be embodied as a computer or a plurality of computers. For example, resource unit development operation server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, resource unit development operation server 210 may be located remotely from the resource unit development data repository 215, the multi-dimensional refined resource unit development structure data repository 220, and/or the external enterprise resource operations data repository 225, although in other embodiments, the resource unit development operation server 210 may comprise the resource unit development data repository 215, the multi-dimensional refined resource unit development structure data repository 220, and/or the external enterprise resource operations data repository 225. The resource unit development operation server 210 may, in some embodiments, comprise several servers or computing devices performing interconnected and/or distributed functions. Despite the many arrangements contemplated herein, resource unit development operation server 210 is shown and described herein as a single computing device to avoid unnecessarily overcomplicating the disclosure.

Resource unit development operation server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the resource unit development operation system 200.

The resource unit development data repository 215 may be stored by any suitable storage device configured to store some or all of the information described herein (e.g., memory 201 of the resource unit development operation server 210 or a separate memory system separate from the resource unit development operation server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The resource unit development data repository 215 may comprise data received from the resource unit development operation server 210 (e.g., via a memory 201 and/or processor(s) 202), and the corresponding storage device may thus store this data. The resource unit development data repository 215 includes information accessed and stored by the resource unit development operation server 210 to facilitate the operations of the resource unit development operation system 200. As such, the resource unit development data repository 215 may include, for example, without limitation, include resource unit development data and/or the like.

The multi-dimensional refined resource unit development structure data repository 220 may be stored by any suitable storage device configured to store some or all of the information described herein (e.g., memory 201 of the resource unit development operation server 210 or a separate memory system separate from the resource unit development operation server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The multi-dimensional refined resource unit development structure data repository 220 may comprise data received from the resource unit development operation server 210 (e.g., via a memory 201 and/or processor(s) 202), and the corresponding storage device may thus store this data. The multi-dimensional refined resource unit development structure data repository 220 includes information accessed and stored by the resource unit development operation server 210 to facilitate the operations of the resource unit development operation system 200. As such, the multi-dimensional refined resource unit development structure data repository 220 may include, for example, without limitation, include resource unit development configuration structures and/or the like.

The external enterprise resource operations data repository 225 may be stored by any suitable storage device configured to store some or all of the information described herein (e.g., memory 201 of the resource unit development operation server 210 or a separate memory system separate from the resource unit development operation server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The external enterprise resource operations data repository 225 may comprise data received from the resource unit development operation server 210 (e.g., via a memory 201 and/or processor(s) 202), and the corresponding storage device may thus store this data. The external enterprise resource operations data repository 225 includes information accessed and stored by the resource unit development operation server 210 to facilitate the operations of the resource unit development operation system 200. As such, the external enterprise resource operations data repository 225 may include, for example, without limitation, include external enterprise resource operations data and/or the like.

Software development tools 106A-106N may be any one or more underlying software development tools (e.g., Bitbucket®, etc.).

The client devices 101A-101N may be implemented as any computing device as defined above. Electronic data received by the resource unit development operation server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the resource operational interface to a user and otherwise providing access to the resource unit development operation system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least the resource operational interface, which may be provided by the resource unit development operation system 200. According to further embodiments, the client devices 101A-101N may be configured to generate and/or display a resource development generation interface component, a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component, and/or the like.

In embodiments where a client device 101A-101N is a mobile device, such as a smartphone or tablet, the client device 101A-101N may execute an “app” to interact with the resource unit development operation system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the resource unit development operation system 200 via a web browser. As yet another example, the client devices 101A-101N may include various hardware or firmware designed to interface with the resource unit development operation system 200.

### Example Apparatus for Implementing Embodiments of the Present Disclosure

FIG. 2 illustrates an example resource unit development operation server 210 in accordance with at least some example embodiments of the present disclosure. In accordance with some example embodiments, resource unit development operation server 210 may include various components, modules, circuitries, or means, some or all of which may be also or instead be included in one or more client device(s) 101A-101N. In accordance with some example embodiments, resource unit development operation server 210 may be configured, using one or more of the sets of circuitry embodying memory 201, processor 202, input/output circuitry 203, communications circuitry 204, and/or resource unit development operation circuitry 205 to execute and perform the operations described herein. In some embodiments, resource unit development operation circuitry 205 is included in resource unit development operation server 210 and/or client device 101A, the circuitry configured to facilitate the functionality discussed herein regarding generating a resource development generation interface component, a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component, and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with resource unit development operation server 210, other elements of the resource unit development operation server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, resource unit development operation server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., resource unit development operation server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling resource unit development operation server 210 to carry out various functions in accordance with example embodiments discussed herein. For example, in at least some embodiments, memory 201 is configured to buffer data for processing by processor 202. Additionally, or alternatively, in at least some embodiments, memory 201 is configured to store program instructions for execution by processor 202. Memory 201 may store information in the form of static and/or dynamic information. This stored information may be stored and/or used by resource unit development operation server 210 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as resource unit development operation server 210. The plurality of processors may be in operative communication with each other and may be collectively configured to perform one or more functionalities of resource unit development operation server 210 as described herein.

In an example embodiment, processor 202 is configured to execute instructions stored in the memory 201 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause resource unit development operation server 210 to perform one or more of the functionalities of resource unit development operation server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., resource operational interface) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in resource unit development operation server 210 may be reduced when implemented also or instead as an end-user machine or other type of device designed for complex user interactions (i.e., client device 101). In some embodiments (like other components discussed herein), input/output circuitry 203 may even be eliminated from resource unit development operation server 210. Alternatively, at least some aspects of input/output circuitry 203 may be embodied on an apparatus used by a user (e.g., a team member, an individual contributor, a team leader, and/or the like) that is in communication with resource unit development operation server 210. Input/output circuitry 203 may be in communication with memory 201, communications circuitry 204, and/or any other component(s), such as via a bus. Although more than one input/output circuitry and/or other component can be included in resource unit development operation server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with resource unit development operation server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by resource unit development operation server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of resource unit development operation server 210, such as via a bus.

In some embodiments, resource unit development operation circuitry 205 may also or instead be included and configured to perform the functionality discussed herein related to providing a resource operational interface, a resource development generation interface component, a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component, and/or the like. Resource unit development operation circuitry 205 includes hardware components and/or software configured to support interface component functionality, features, and/or services of the resource unit development operation server 210. In some embodiments, resource unit development operation circuitry 205 includes hardware components and/or software configured to support a resource unit development link prediction model to generate and/or determine predicted resource unit development links, features, and/or services of the resource unit development operation server 210. The resource unit development operation circuitry 205 may utilize processing circuitry, such as the processor 202, to perform its corresponding operations, and may utilize memory 201 to store collected information. The resource unit development operation circuitry 205 may send and/or receive data from resource unit development data repository 215, the multi-dimensional refined resource unit development structure data repository 220, and/or the external enterprise resource operations data repository 225. In some implementations, the sent and/or received data may include resource unit development data, external enterprise resource operations data, refinement candidate resource unit development structures, multi-dimensional refined resource unit development structures, resource unit development configuration structures, updated multi-dimensional refined resource unit development structures, resource unit development items, and associated data that is associated with, for example, generating a resource operational interface, a resource development generation interface component, a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component, and/or the like.

It should also be appreciated that, in some embodiments, the resource unit development operation circuitry 205 may include a separate processor, specially configured field programmable gate array (FPGA), or application specific interface circuit (ASIC) to perform its corresponding functions. For example, in some embodiments, some or all of the functionality of resource unit development operation circuitry 205 may be performed by processor 202. In this regard, some or all of the example processes and algorithms discussed herein can be performed by at least one processor 202 and/or resource unit development operation circuitry 205. For example, non-transitory computer readable storage media can be configured to store firmware, one or more application programs, and/or other software, which include instructions and other computer-readable program code portions that can be executed to control processors of the components of resource unit development operation server 210 to implement various operations, including the examples shown herein. As such, a series of computer-readable program code portions may be embodied in one or more computer program products and can be used, with a device, resource unit development operation server 210, database, and/or other programmable apparatus, to produce the machine-implemented processes discussed herein. It is also noted that all or some of the information discussed herein can be based on data that is received, generated and/or maintained by one or more components of the resource unit development operation server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of resource unit development operation server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

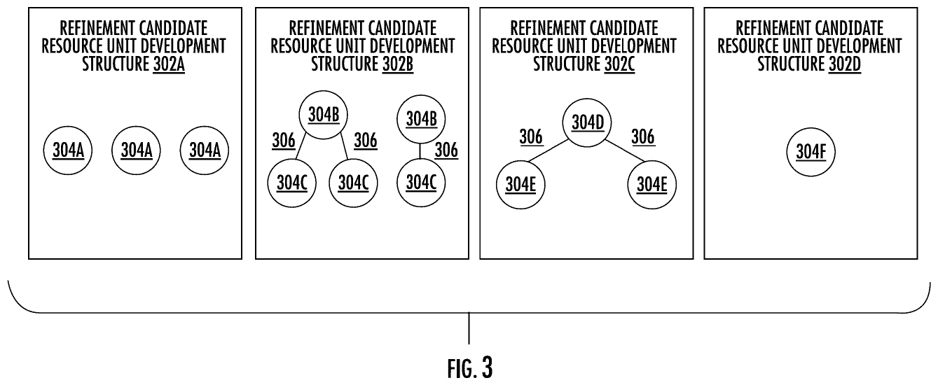

In various embodiments of the present disclosure, an apparatus (e.g., the resource unit development operation server 210) may be configured to generate, output, manage, and/or cause rendering of a visualization of one or more refinement candidate resource unit development structures. For example, an apparatus (e.g., the resource unit development operation server 210) may be configured to output and/or cause rendering of a visualization of one or more refinement candidate resource unit development structures. FIG. 3 illustrates an example visualization of four refinement candidate resource unit development structures 302A, 302B, 302C, and 302D structured in accordance with various embodiments of the present disclosure. In some embodiments, the apparatus (e.g., resource unit development operation server 210) causes rendering of the visualization of four refinement candidate resource unit development structures 302A, 302B, 302C, and 302D to a visual display of a computing device (e.g., a client device 101A-101N).

In some embodiments, the visualization of refinement candidate resource unit development structure 302A may include one or more representations of one or more resource unit development items. For example, the visualization of refinement candidate resource unit development structure 302A may include a representation of one or more resource unit development project identifier items 304A.

In some embodiments, the visualization of refinement candidate resource unit development structure 302B may include one or more representations of one or more resource unit development items. For example, the visualization of refinement candidate resource unit development structure 302B may include a representation of one or more resource unit development user identifier items 304B and/or one or more resource unit development team identifier items 304C. Additionally, or alternatively, the visualization of refinement candidate resource unit development structure 302B may include one or more representations of one or more explicit resource unit development links. For example, the visualization of refinement candidate resource unit development structure 302B may include a representation of one or more explicit resource unit development links 306.

In some embodiments, the visualization of refinement candidate resource unit development structure 302C may include one or more representations of one or more resource unit development items. For example, the visualization of refinement candidate resource unit development structure 302C may include a representation of one or more resource unit development objective identifier items 304D and/or one or more resource unit development milestone identifier items 304E. Additionally, or alternatively, the visualization of refinement candidate resource unit development structure 302C may include one or more representations of one or more explicit resource unit development links. For example, the visualization of refinement candidate resource unit development structure 302C may include a representation of one or more explicit resource unit development links 306.

In some embodiments, the visualization of refinement candidate resource unit development structure 302D may include one or more representations of one or more resource unit development items. For example, the visualization of refinement candidate resource unit development structure 302D may include a representation of one or more resource unit development allocation identifier items 304F.

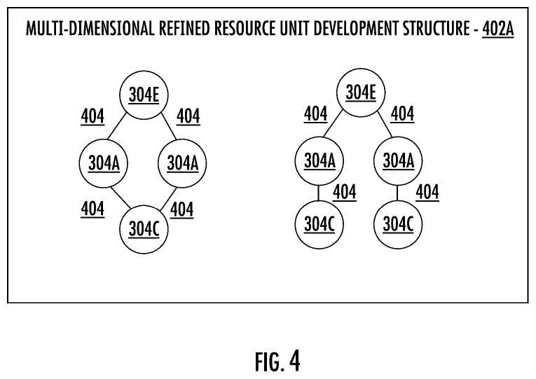

In various embodiments of the present disclosure, an apparatus (e.g., the resource unit development operation server 210) may be configured to generate, output, manage, and/or cause rendering of a visualization of one or more multi-dimensional refined resource unit development structures. For example, an apparatus (e.g., the resource unit development operation server 210) may be configured to output and/or cause rendering of a visualization of one or more multi-dimensional refined resource unit development structures. FIG. 4 illustrates an example visualization of a multi-dimensional refined resource unit development structure 402A in accordance with various embodiments of the present disclosure. In some embodiments, the apparatus (e.g., resource unit development operation server 210) causes rendering of the visualization of the multi-dimensional refined resource unit development structure 402A to a visual display of a computing device (e.g., a client device 101A-101N).

In some embodiments, the visualization of the multi-dimensional refined resource unit development structure 402A may include one or more representations of one or more resource unit development items. For example, the visualization of the multi-dimensional refined resource unit development structure 402A may include a representation of one or more resource unit development project identifier items 304A, one or more resource unit development team identifier items 304C, and/or one or more resource unit development milestone identifier items 304E. Additionally, or alternatively, the visualization of the multi-dimensional refined resource unit development structure 402A may include one or more representations of one or more predicted resource unit development links. For example, the visualization of the multi-dimensional refined resource unit development structure 402A may include one or more representations of one or more predicted resource unit development links 404.

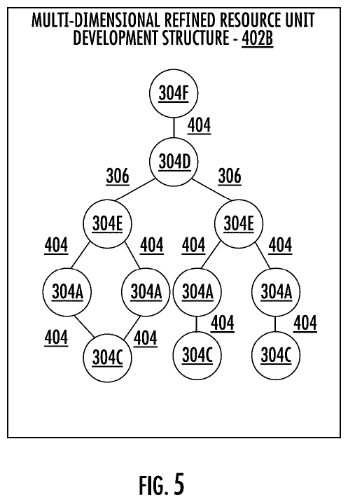

In various embodiments of the present disclosure, an apparatus (e.g., the resource unit development operation server 210) may be configured to generate, output, manage, and/or cause rendering of a visualization of one or more multi-dimensional refined resource unit development structures. For example, an apparatus (e.g., the resource unit development operation server 210) may be configured to output and/or cause rendering of a visualization of one or more multi-dimensional refined resource unit development structures. FIG. 5 illustrates an example visualization of a multi-dimensional refined resource unit development structure 402B in accordance with various embodiments of the present disclosure. In some embodiments, the apparatus (e.g., resource unit development operation server 210) causes rendering of the visualization of the multi-dimensional refined resource unit development structure 402B to a visual display of a computing device (e.g., a client device 101A-101N).

In some embodiments, the visualization of the multi-dimensional refined resource unit development structure 402B may include one or more representations of one or more resource unit development items. For example, the visualization of the multi-dimensional refined resource unit development structure 402B may include a representation of one or more resource unit development project identifier items 304A, one or more resource unit development team identifier items 304C, one or more resource unit development objective identifier items 304D, one or more resource unit development milestone identifier items 304E, and/or one or more resource unit development allocation identifier items 304F. Additionally, or alternatively, the visualization of the multi-dimensional refined resource unit development structure 402B may include one or more representations of one or more predicted resource unit development links. For example, the visualization of the multi-dimensional refined resource unit development structure 402B may include one or more representations of one or more predicted resource unit development links 404. Additionally, or alternatively, the visualization of the multi-dimensional refined resource unit development structure 402B may include one or more representations of one or more explicit resource unit development links. For example, the visualization of the multi-dimensional refined resource unit development structure 402B may include one or more representations of one or more explicit resource unit development links 306.

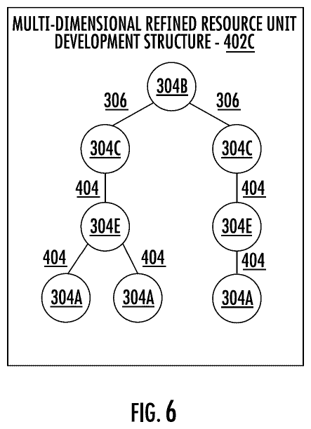

In various embodiments of the present disclosure, an apparatus (e.g., the resource unit development operation server 210) may be configured to generate, output, manage, and/or cause rendering of a visualization of one or more multi-dimensional refined resource unit development structures. For example, an apparatus (e.g., the resource unit development operation server 210) may be configured to output and/or cause rendering of a visualization of one or more multi-dimensional refined resource unit development structures. FIG. 6 illustrates an example visualization of a multi-dimensional refined resource unit development structure 402C in accordance with various embodiments of the present disclosure. In some embodiments, the apparatus (e.g., resource unit development operation server 210) causes rendering of the visualization of the multi-dimensional refined resource unit development structure 402C to a visual display of a computing device (e.g., a client device 101A-101N).

In some embodiments, the visualization of the multi-dimensional refined resource unit development structure 402C may include one or more representations of one or more resource unit development items. For example, the visualization of the multi-dimensional refined resource unit development structure 402C may include a representation of one or more resource unit development project identifier items 304A, one or more resource unit development user identifier items 304B, one or more resource unit development team identifier items 304C, and/or one or more resource unit development milestone identifier items 304E. Additionally, or alternatively, the visualization of the multi-dimensional refined resource unit development structure 402C may include one or more representations of one or more predicted resource unit development links. For example, the visualization of the multi-dimensional refined resource unit development structure 402C may include one or more representations of one or more predicted resource unit development links 404. Additionally, or alternatively, the visualization of the multi-dimensional refined resource unit development structure 402C may include one or more representations of one or more explicit resource unit development links. For example, the visualization of the multi-dimensional refined resource unit development structure 402C may include one or more representations of one or more explicit resource unit development links 306.

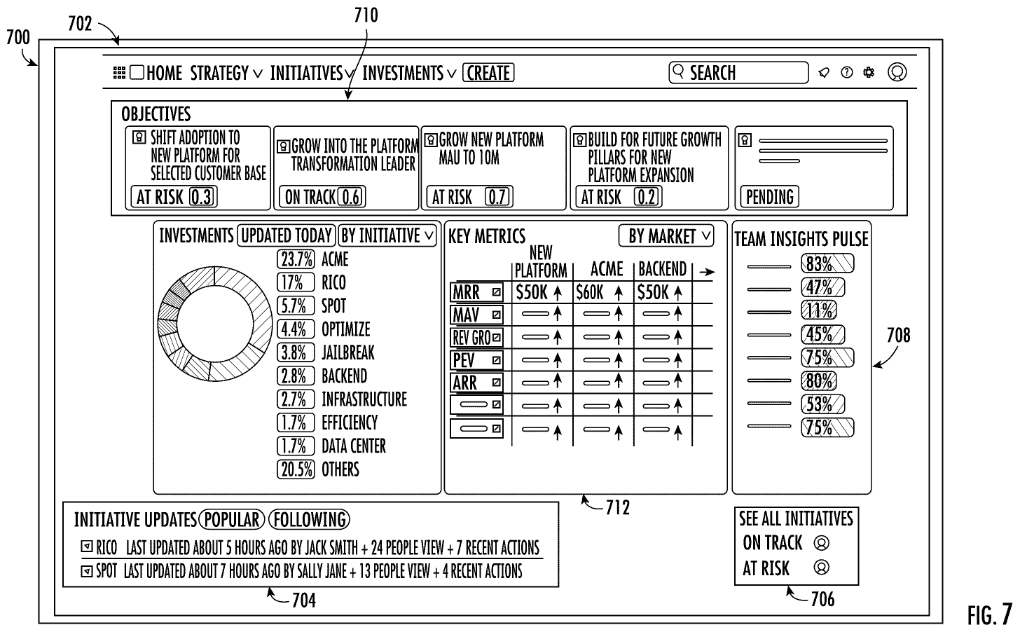

In various embodiments of the present disclosure, an apparatus (e.g., the resource unit development operation server 210) may be configured to generate, output, manage, and/or cause rendering of a resource development generation interface component of a resource unit development operation system 200. For example, an apparatus (e.g., the resource unit development operation server 210) may be configured to output and/or cause rendering of a resource development generation interface component on a resource operational interface 700 of the resource unit development operation system 200. FIG. 7 illustrates an example resource development generation interface component 702 structured in accordance with various embodiments of the present disclosure. In some embodiments, the apparatus (e.g., resource unit development operation server 210) causes rendering of the resource development generation interface component 702 to a visual display of a computing device (e.g., a client device 101A-101N).

In some embodiments, the resource development generation interface component 702 may be configured to display one or more resource unit development items. In some embodiments, the resource development generation interface component 702 may be configured to display one or more resource unit development items associated with an enterprise associated with a resource unit development operation system 200. For example, a resource development generation interface component may be configured to display a resource unit development user identifier item 706 associated with users of an enterprise associated with a resource unit development operation system 200. As another example, a resource development generation interface component 702 may be configured to display a resource unit development team identifier item 708 associated with teams of an enterprise associated with a resource unit development operation system 200. As another example, a resource development generation interface component 702 may be configured to display a resource unit development project identifier item 704 associated with projects of an enterprise associated with a resource unit development operation system 200. As another example, a resource development generation interface component 702 may be configured to display a resource unit development milestone identifier item 712 associated with milestones of an enterprise associated with a resource unit development operation system 200. As another example, a resource development generation interface component 702 may be configured to display a resource unit development objective identifier item 710 associated with objectives of an enterprise associated with a resource unit development operation system 200.

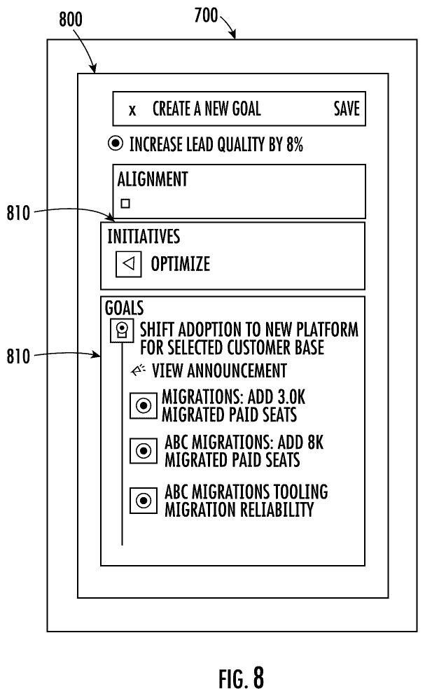

In various embodiments of the present disclosure, an apparatus (e.g., the resource unit development operation server 210) may be configured to generate, output, manage, and/or cause rendering of a resource development individual generation interface component of a resource unit development operation system 200. For example, an apparatus (e.g., the resource unit development operation server 210) may be configured to output and/or cause rendering of a resource development individual generation interface component on a resource operational interface 700 of the resource unit development operation system 200. FIG. 8 illustrates an example resource development individual generation interface component 800 structured in accordance with various embodiments of the present disclosure. In some embodiments, the apparatus (e.g., resource unit development operation server 210) causes rendering of the resource development individual generation interface component 800 to a visual display of a computing device (e.g., a client device 101A-101N).

In some embodiments, the resource development individual generation interface component 800 may be configured to display one or more resource unit development items. In some embodiments, the resource development individual generation interface component 800 may be configured to display one or more resource unit development items associated with a user associated with a resource unit development operation system 200. For example, a resource development individual generation interface component may be configured to display a resource unit development objective identifier item 810 associated with users of an enterprise associated with a resource unit development operation system 200. As another example, a resource development individual generation interface component 800 may be configured to display a resource unit development milestone identifier item 812 associated with milestones of a user associated with a resource unit development operation system 200.

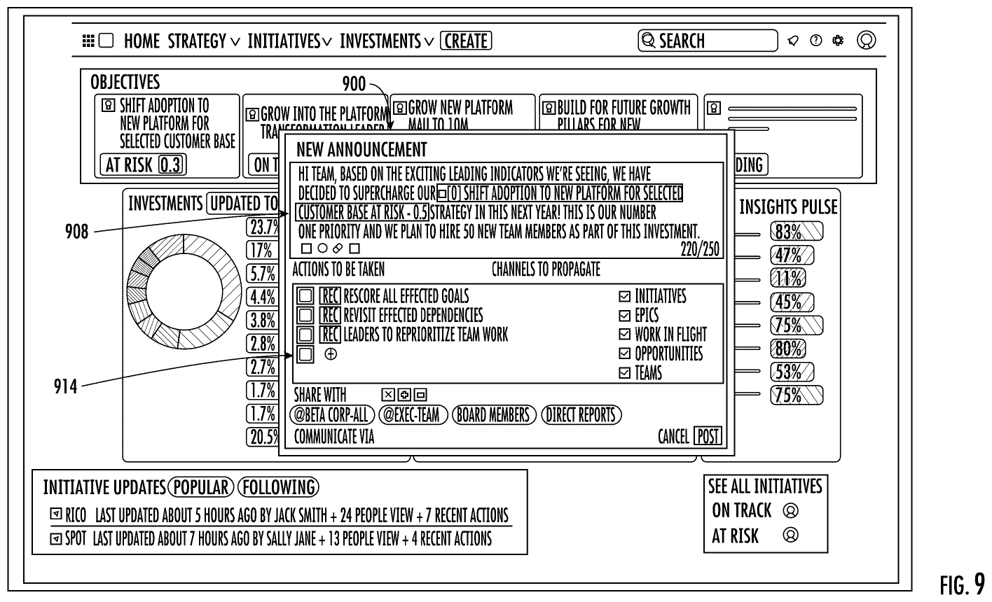

In various embodiments of the present disclosure, an apparatus (e.g., the resource unit development operation server 210) may be configured to generate, output, manage, and/or cause rendering of a resource development enterprise communication generation interface component of a resource unit development operation system 200. For example, an apparatus (e.g., the resource unit development operation server 210) may be configured to output and/or cause rendering of a resource development enterprise communication generation interface component on a resource operational interface 700 of the resource unit development operation system 200. In various embodiments of the present disclosure, an apparatus (e.g., the resource unit development operation server 210) may be configured to generate, output, manage, and/or cause rendering of a resource development enterprise communication generation interface component of a resource unit development operation system 200 such that the resource development enterprise communication generation interface component is displayed proximate to, overlaid on, and/or as a portion of a resource development generation interface component 702 and/or another interface component of a resource unit development operation system 200. FIG. 9 illustrates an example resource development enterprise communication generation interface component 900 structured in accordance with various embodiments of the present disclosure. In some embodiments, the apparatus (e.g., resource unit development operation server 210) causes rendering of the resource development enterprise communication generation interface component 900 to a visual display of a computing device (e.g., a client device 101A-101N).

In some embodiments, the resource development enterprise communication generation interface component 900 may be configured to display one or more resource unit development items. In some embodiments, the resource development enterprise communication generation interface component 900 may be configured to display one or more resource unit development items associated with enterprise communications associated with a resource unit development operation system 200. For example, a resource development enterprise communication generation interface component may be configured to display a resource unit development team identifier item 908 associated with communications related to one or more teams associated with an enterprise associated with a resource unit development operation system 200. As another example, a resource development enterprise communication generation interface component 900 may be configured to display a resource unit development allocation identifier item 914 associated with communications associated with allocations of an enterprise associated with a resource unit development operation system 200.

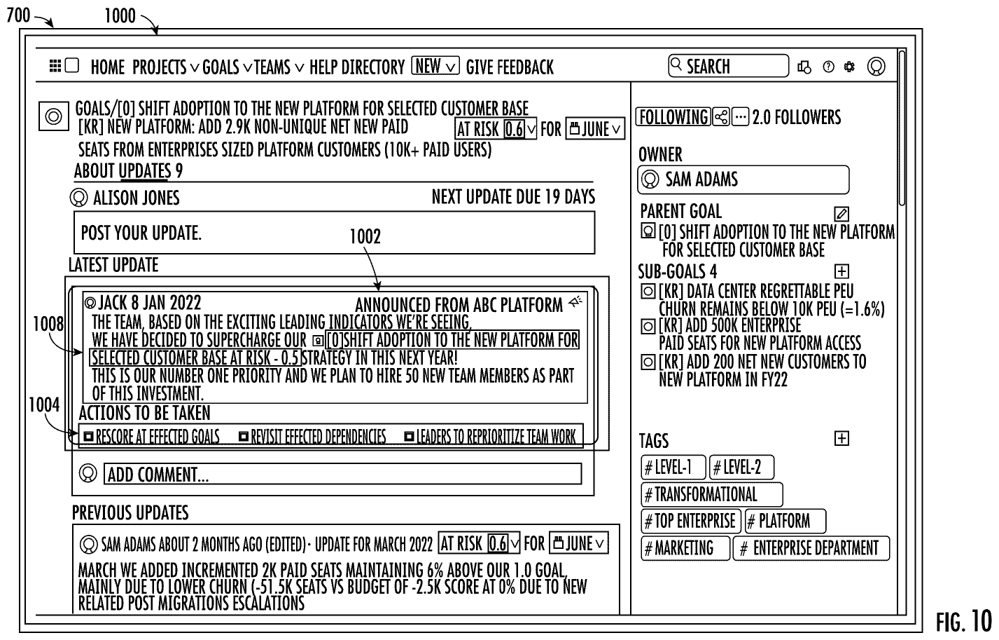

In various embodiments of the present disclosure, an apparatus (e.g., the resource unit development operation server 210) may be configured to generate, output, manage, and/or cause rendering of a resource development team communication generation interface component of a resource unit development operation system 200. For example, an apparatus (e.g., the resource unit development operation server 210) may be configured to output and/or cause rendering of a resource development team communication generation interface component on a resource operational interface 700 of the resource unit development operation system 200. In various embodiments of the present disclosure, an apparatus (e.g., the resource unit development operation server 210) may be configured to generate, output, manage, and/or cause rendering of a resource development team communication generation interface component of a resource unit development operation system 200 such that the resource development team communication generation interface component is displayed proximate to, overlaid on, and/or as a portion of another interface component 1000 of a resource unit development operation system 200. FIG. 10 illustrates an example resource development team communication generation interface component 1002 structured in accordance with various embodiments of the present disclosure. In some embodiments, the apparatus (e.g., resource unit development operation server 210) causes rendering of the resource development team communication generation interface component 1002 to a visual display of a computing device (e.g., a client device 101A-101N).

In some embodiments, the resource development team communication generation interface component 1002 may be configured to display one or more resource unit development items. In some embodiments, the resource development team communication generation interface component 1002 may be configured to display one or more resource unit development items associated with communications of one or more teams associated with a resource unit development operation system 200. For example, a resource development team communication generation interface component may be configured to display a resource unit development team identifier item 1008 associated with a communication of one or more teams associated with a resource unit development operation system 200. As another example, a resource development team communication generation interface component 1002 may be configured to display a resource unit development project identifier item 1004 associated with communications associated with a project associated with a resource unit development operation system 200.

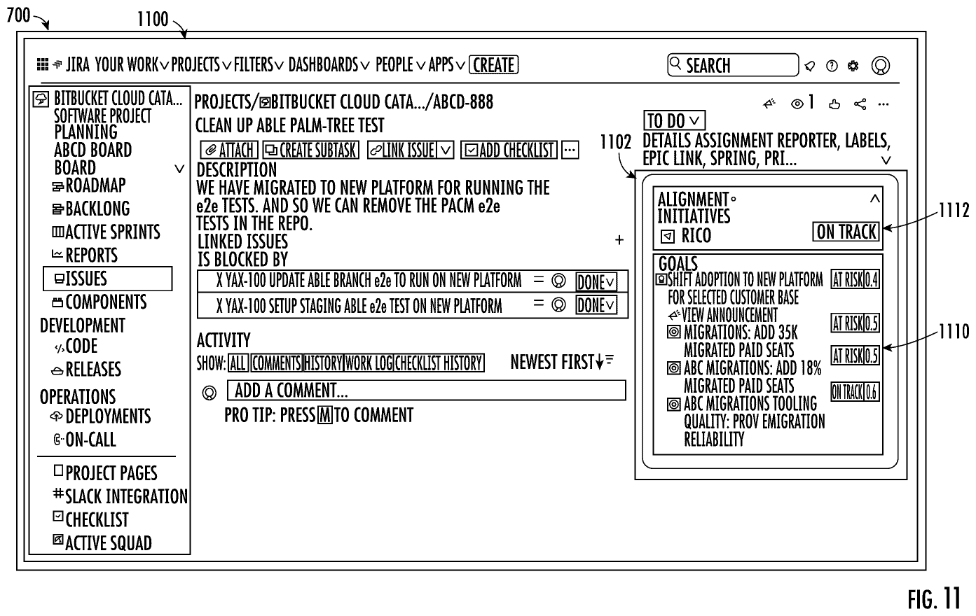

In various embodiments of the present disclosure, an apparatus (e.g., the resource unit development operation server 210) may be configured to generate, output, manage, and/or cause rendering of a resource development summary generation interface component of a resource unit development operation system 200. For example, an apparatus (e.g., the resource unit development operation server 210) may be configured to output and/or cause rendering of a resource development summary generation interface component on a resource operational interface 700 of the resource unit development operation system 200. In various embodiments of the present disclosure, an apparatus (e.g., the resource unit development operation server 210) may be configured to generate, output, manage, and/or cause rendering of a resource development summary generation interface component of a resource unit development operation system 200 such that the resource development summary generation interface component is displayed proximate to, overlaid on, and/or as a portion of another interface component 1100 of a resource unit development operation system 200. FIG. 11 illustrates an example resource development summary generation interface component 1102 structured in accordance with various embodiments of the present disclosure. In some embodiments, the apparatus (e.g., resource unit development operation server 210) causes rendering of the resource development summary generation interface component 1102 to a visual display of a computing device (e.g., a client device 101A-101N).

In some embodiments, the resource development summary generation interface component 1102 may be configured to display one or more resource unit development items. In some embodiments, the resource development summary generation interface component 1102 may be configured to display one or more resource unit development items associated with a summary of one or more resource unit development items associated with a resource unit development operation system 200. For example, a resource development summary generation interface component may be configured to display a resource unit development milestone identifier item 1112 associated with a summary of a milestone associated with a resource unit development operation system 200. As another example, a resource development summary generation interface component 1102 may be configured to display a resource unit development objective identifier item 1110 associated with a summary of an objective associated with a resource unit development operation system 200.

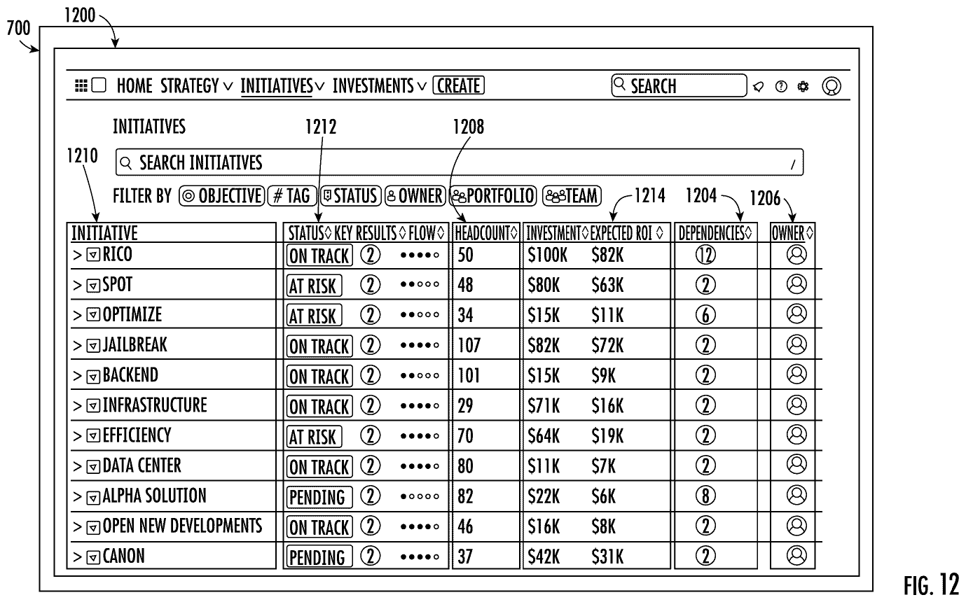

In various embodiments of the present disclosure, an apparatus (e.g., the resource unit development operation server 210) may be configured to generate, output, manage, and/or cause rendering of a resource development aggregated impact interface component of a resource unit development operation system 200. For example, an apparatus (e.g., the resource unit development operation server 210) may be configured to output and/or cause rendering of a resource development aggregated impact interface component on a resource operational interface 700 of the resource unit development operation system 200. FIG. 12 illustrates an example resource development aggregated impact interface component 1200 structured in accordance with various embodiments of the present disclosure. In some embodiments, the apparatus (e.g., resource unit development operation server 210) causes rendering of the resource development aggregated impact interface component 1200 to a visual display of a computing device (e.g., a client device 101A-101N).

In some embodiments, the resource development aggregated impact interface component 1200 may be configured to display one or more resource unit development items. In some embodiments, the resource development aggregated impact interface component 1200 may be configured to display one or more resource unit development items associated with an aggregated list of resource unit development items associated with a resource unit development operation system 200. For example, a resource development aggregated impact interface component may be configured to display a resource unit development objective identifier item 1210 associated with an aggregated list of resource unit development objective identifier items associated with a resource unit development operation system 200. As another example, a resource development aggregated impact interface component 1200 may be configured to display a resource unit development milestone identifier item 1212 associated with an aggregated list of resource unit development milestone identifier items associated with a resource unit development operation system 200. As another example, a resource development aggregated impact interface component 1200 may be configured to display a resource unit development team identifier item 1208 associated with an aggregated list of resource unit development team identifier items associated with a resource unit development operation system 200. As another example, a resource development aggregated impact interface component 1200 may be configured to display a resource unit development allocation identifier item 1214 associated with an aggregated list of resource unit development allocation identifier items associated with a resource unit development operation system 200. As another example, a resource development aggregated impact interface component 1200 may be configured to display a resource unit development project identifier item 1204 associated with an aggregated list of resource unit development project identifier items associated with a resource unit development operation system 200. As another example, a resource development aggregated impact interface component 1200 may be configured to display a resource unit development user identifier item 1206 associated with an aggregated list of resource unit development user identifier items associated with a resource unit development operation system 200.

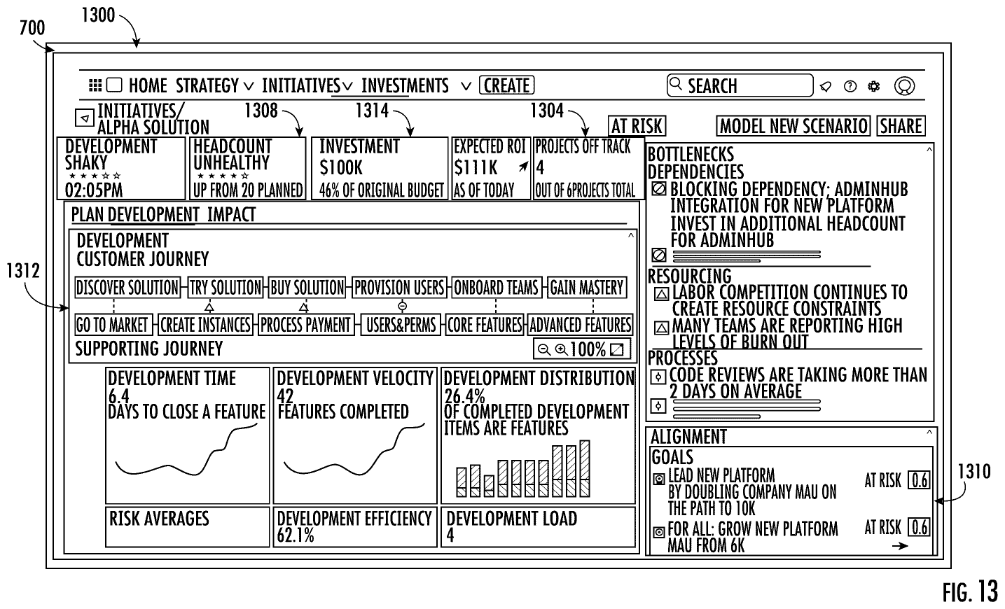

In various embodiments of the present disclosure, an apparatus (e.g., the resource unit development operation server 210) may be configured to generate, output, manage, and/or cause rendering of a resource development impact interface component of a resource unit development operation system 200. For example, an apparatus (e.g., the resource unit development operation server 210) may be configured to output and/or cause rendering of a resource development impact interface component on a resource operational interface 700 of the resource unit development operation system 200. FIG. 13 illustrates an example resource development impact interface component 1300 structured in accordance with various embodiments of the present disclosure. In some embodiments, the apparatus (e.g., resource unit development operation server 210) causes rendering of the resource development impact interface component 1300 to a visual display of a computing device (e.g., a client device 101A-101N).

In some embodiments, the resource development impact interface component 1300 may be configured to display one or more resource unit development items. In some embodiments, the resource development impact interface component 1300 may be configured to display one or more resource unit development items associated with an impact associated with a resource unit development operation system 200. For example, a resource development impact interface component may be configured to display a resource unit development milestone identifier item 1312 associated with the impact of a milestone associated with a resource unit development operation system 200. As another example, a resource development impact interface component 1300 may be configured to display a resource unit development team identifier item 1308 associated with the impact of a team associated with a resource unit development operation system 200. As another example, a resource development impact interface component 1300 may be configured to display a resource unit development allocation identifier item 1314 associated with the impact of an allocation associated with a resource unit development operation system 200. As another example, a resource development impact interface component 1300 may be configured to display a resource unit development project identifier item 1304 associated with the impact of a project associated with a resource unit development operation system 200. As another example, a resource development impact interface component 1300 may be configured to display a resource unit development objective identifier item 1310 associated with the impact of an objective associated with a resource unit development operation system 200.

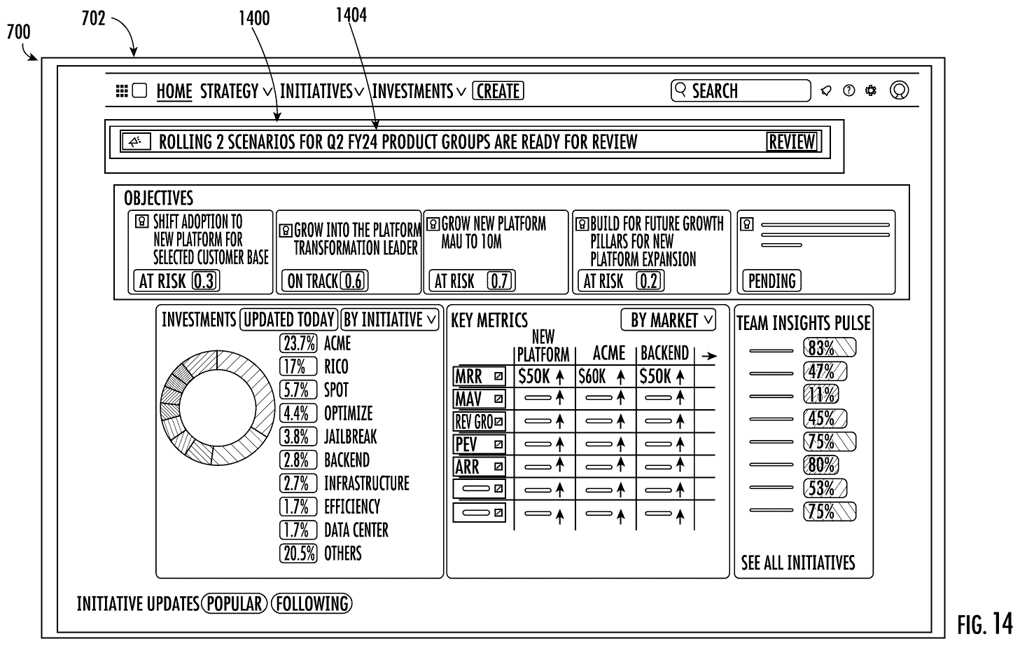

In various embodiments of the present disclosure, an apparatus (e.g., the resource unit development operation server 210) may be configured to generate, output, manage, and/or cause rendering of a resource development aggregated implementation interface component of a resource unit development operation system 200. For example, an apparatus (e.g., the resource unit development operation server 210) may be configured to output and/or cause rendering of a resource development aggregated implementation interface component on a resource operational interface 700 of the resource unit development operation system 200. In various embodiments of the present disclosure, an apparatus (e.g., the resource unit development operation server 210) may be configured to generate, output, manage, and/or cause rendering of a resource development aggregated implementation interface component of a resource unit development operation system 200 such that the resource development aggregated implementation interface component is displayed proximate to, overlaid on, and/or as a portion of a resource development generation interface component 702 and/or another interface component of a resource unit development operation system 200. FIG. 14 illustrates an example resource development aggregated implementation interface component 1400 structured in accordance with various embodiments of the present disclosure. In some embodiments, the apparatus (e.g., resource unit development operation server 210) causes rendering of the resource development aggregated implementation interface component 1400 to a visual display of a computing device (e.g., a client device 101A-101N).

In some embodiments, the resource development aggregated implementation interface component 1400 may be configured to display one or more resource unit development items. In some embodiments, the resource development aggregated implementation interface component 1400 may be configured to display an aggregated list of resource unit development items associated with a resource unit development operation system 200 that have been implemented. For example, a resource development aggregated implementation interface component may be configured to display a resource unit development project identifier item 1404 associated with an aggregated group of projects associated with a resource unit development operation system 200 that has been implemented.

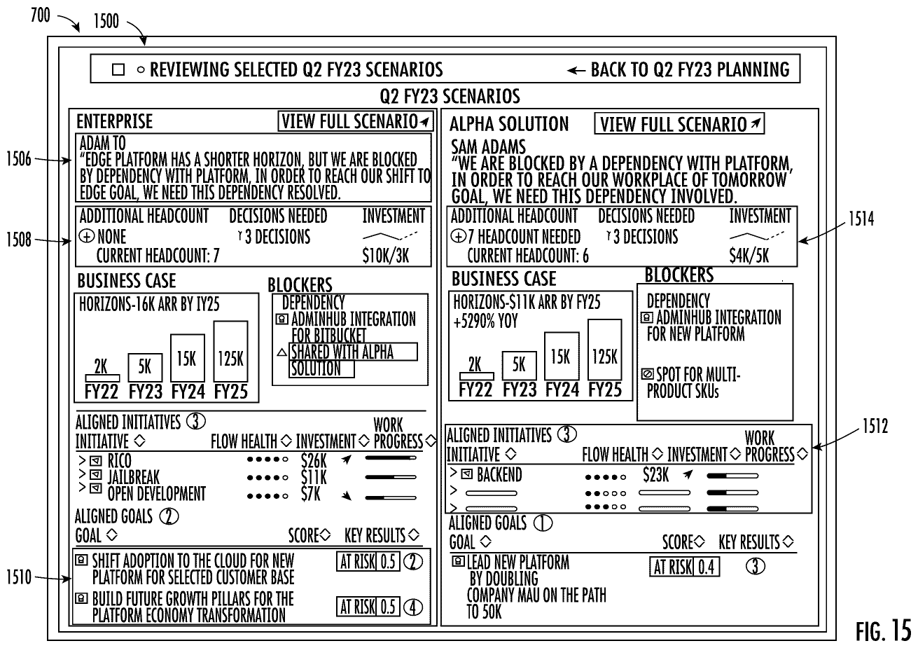

In various embodiments of the present disclosure, an apparatus (e.g., the resource unit development operation server 210) may be configured to generate, output, manage, and/or cause rendering of a resource development implementation interface component of a resource unit development operation system 200. For example, an apparatus (e.g., the resource unit development operation server 210) may be configured to output and/or cause rendering of a resource development implementation interface component on a resource operational interface 700 of the resource unit development operation system 200. FIG. 15 illustrates an example resource development implementation interface component 1500 structured in accordance with various embodiments of the present disclosure. In some embodiments, the apparatus (e.g., resource unit development operation server 210) causes rendering of the resource development implementation interface component 1500 to a visual display of a computing device (e.g., a client device 101A-101N).

In some embodiments, the resource development implementation interface component 1500 may be configured to display one or more resource unit development items. In some embodiments, the resource development implementation interface component 1500 may be configured to display one or more resource unit development items associated with a resource unit development operation system 200 that have been implemented. For example, a resource development implementation interface component may be configured to display a resource unit development user identifier item 1506 associated with a user associated with a resource unit development operation system 200 that has been implemented. As another example, a resource development implementation interface component 1500 may be configured to display a resource unit development team identifier item 1508 associated with a team associated with a resource unit development operation system 200 that has been implemented. As another example, a resource development implementation interface component 1500 may be configured to display a resource unit development objective identifier item 1510 associated with an objective associated with a resource unit development operation system 200 that has been implemented. As another example, a resource development implementation interface component 1500 may be configured to display a resource unit development milestone identifier item 1512 associated with a milestone associated with a resource unit development operation system 200 that has been implemented. As another example, a resource development implementation interface component 1500 may be configured to display a resource unit development allocation identifier item 1514 associated with an allocation associated with a resource unit development operation system 200 that has been implemented.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to output and/or provide a resource operational interface, a resource development generation interface component, a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component, and/or the like in a resource unit development operation system 200 in a number of ways

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

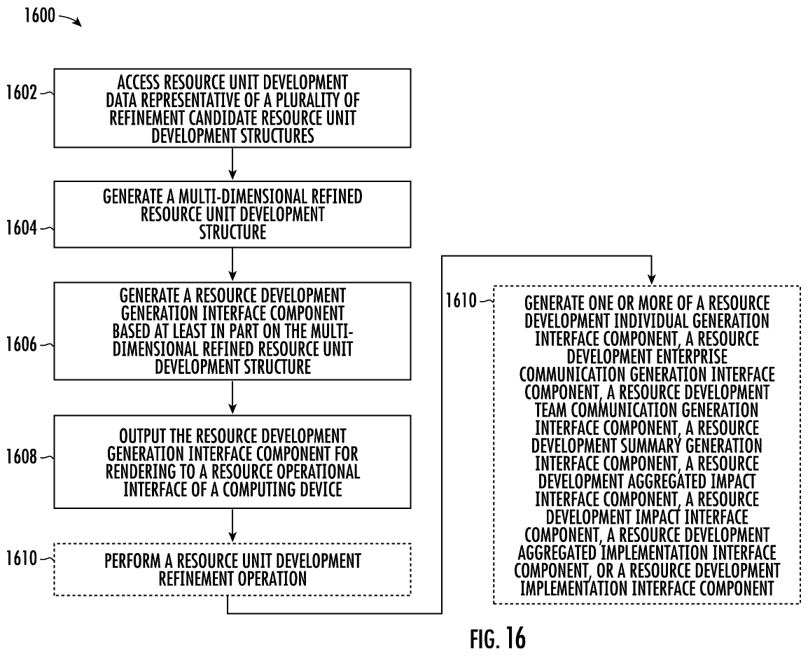

FIG. 16 is a flowchart broadly illustrating a series of operations or process blocks that are executed or performed to output a resource development generation interface component for rendering to a resource operational interface and/or one or more other interface components to a resource operational interface in a resource unit development operation system in accordance with some example embodiments of the present disclosure. In some embodiments, the method 1600 is embodied by computer program code stored on a non-transitory computer-readable storage medium of a computer program product configured for execution to perform the process as depicted and described. In this regard, in some such embodiments, the resource unit development operation server 210 is specially configured by computer-coded instructions (e.g., computer program instructions) stored thereon, for example in the memory 201 and/or another component depicted and/or described herein and/or otherwise accessible to the resource unit development operation server 210, for performing the operations as depicted and described. Alternatively, or additionally, in some embodiments, the method 1600 is performed by one or more specially configured computing devices, such as the resource unit development operation server 210 alone or in communication with one or more other component(s), device(s), system(s), and/or the like. For example, in some embodiments, the resource unit development operation server 210 is in communication with one or more external apparatus(es), system(s), device(s), and/or the like, to perform one or more of the operations as depicted and described. For purposes of simplifying the description, the method 1600 is described as performed by and from the perspective of the resource unit development operation server 210. In this regard, performance of the operations may invoke one or more of memory 201, processor 202, input/output circuitry 203, communications circuitry 204, and/or resource unit development operation circuitry 205.

In the embodiment illustrated in FIG. 16, the flowchart illustrates method 1600 which begins at block 1602. At block 1602, the resource unit development operation server 210 includes means, such as the memory 201, processor 202, input/output circuitry 203, communications circuitry 204, and/or resource unit development operation circuitry 205, or a combination thereof, to access resource unit development data representative of a plurality of refinement candidate resource unit development structures. In some embodiments, one or more items of data indicative and/or representative of one or more refinement candidate resource unit development structures. For example, the resource unit development data may be one or more items of data indicative and/or representative of one or more resource unit development items and/or one or more explicit resource unit development links.

In some embodiments, each of the plurality of refinement candidate resource unit development structures may be a domain-specific data structure of an aggregation of resource unit development items and/or a domain-specific data structure of an aggregation of explicit resource unit development links configured in an at least partially ordered structure in a resource unit development operation system. In some embodiments, a refinement candidate resource unit development structure may be associated with one or more unrefined links, unrefined connections, unrefined relationships, unrefined associations, unrefined bonds, and/or the like between one or more of the resource unit development items in the refinement candidate resource unit development structure and/or one or more other resource unit development items.

In some embodiments, a resource unit development item may be a data object that is representative of and/or associated with a project, a user, a team, an objective, a milestone, and/or an allocation. For example, a resource unit development item may include or correspond to a resource unit development project identifier item, resource unit development user identifier item, resource unit development team identifier item, resource unit development objective identifier item, resource unit development milestone identifier item, and/or a resource unit development allocation identifier item.

In some embodiments, an explicit resource unit development link may be a data object representative of and/or associated with a link, connection, relationship, association, bond, and/or the like between one or more resource unit development items that was defined at the generation of the one or more resource unit development items. In some embodiments, an explicit resource unit development link may be a data object representative of and/or associated with a link, connection, relationship, association, bond, and/or the like between one or more resource unit development items that are in the same refinement candidate resource unit development structure. For example, an explicit resource unit development link may be data object representative of and/or associated with a link, connection, relationship, association, bond, and/or the like between a first resource unit development item associated with a first refinement candidate resource unit development structure and a second resource unit development item associated with the first refinement candidate resource unit development structure.

At block 1604, the resource unit development operation server 210 includes means, such as the memory 201, processor 202, input/output circuitry 203, communications circuitry 204, and/or resource unit development operation circuitry 205, or a combination thereof, to generate a multi-dimensional refined resource unit development structure. In some embodiments, a multi-dimensional refined resource unit development structure may be a domain-specific data structure of an aggregation of resource unit development items, a domain-specific data structure of an aggregation of predicted resource unit development links, and/or a domain-specific data structure of an aggregation of explicit resource unit development links configured in an at least partially ordered structure in a resource unit development operation system. In some embodiments, generating a multi-dimensional refined resource unit development structure may include determining at least one predicted resource unit development link.

In some embodiments, a predicted resource unit development link a data object representative of and/or associated with a link, connection, relationship, association, bond, and/or the like between one or more resource unit development items that is generated by a resource unit development operation system using a resource unit development link prediction model. In some embodiments, a resource unit development link prediction model may be a data entity that describes parameters, hyper-parameters, and/or defined operations of a rules-based and/or machine learning model (e.g., model including at least one of one or more rule-based layers, one or more layers that depend on trained parameters, coefficients, and/or the like). In some embodiments, a resource unit development operation system may be configured to determine one or more predicted resource unit development links using a resource unit development link prediction model. In this regard, for example, a resource unit development operation system may be configured to at least in part perform a resource unit development refinement operation using a resource unit development link prediction model. In some embodiments, a resource unit development link prediction model may be trained using resource unit development data and/or external enterprise resource operations data.

At block 1606, the resource unit development operation server 210 includes means, such as the memory 201, processor 202, input/output circuitry 203, communications circuitry 204, and/or resource unit development operation circuitry 205, or a combination thereof, to generate a resource development generation interface component based at least in part on the multi-dimensional refined resource unit development structure. In some embodiments, the resource development generation interface component includes at least one of the plurality of resource unit development items. In some embodiments, generating the resource development generation interface component includes selecting at least one of a plurality of resource unit development items based at least in part on at least one predicted resource unit development link.

At block 1608, the resource unit development operation server 210 includes means, such as the memory 201, processor 202, input/output circuitry 203, communications circuitry 204, and/or resource unit development operation circuitry 205, or a combination thereof, to output the resource development generation interface component for rendering to a resource operational interface of a computing device.

At optional block 1610, the resource unit development operation server 210 includes means, such as the memory 201, processor 202, input/output circuitry 203, communications circuitry 204, and/or resource unit development operation circuitry 205, or a combination thereof, to perform a resource unit development refinement operation. In some embodiments, a resource unit development refinement operation may be a data object that provides refinement commands, refinement directives, and/or refinement specifications for conducting refinement operations to generate one or more predicted resource unit development links. In some embodiments, by providing refinement commands, refinement directives, and/or refinement specifications, a resource unit development refinement operation may be configured to access external enterprise resource operations data, parse external enterprise resource operations data to identify one or more resource unit development items, determine one or more resource unit development configuration structures associated with one or more of a plurality of resource unit development items, and determine one or more predicted resource unit development links based at least in part on a resource unit development configuration structure.

At optional block 1612, the resource unit development operation server 210 includes means, such as the memory 201, processor 202, input/output circuitry 203, communications circuitry 204, and/or resource unit development operation circuitry 205, or a combination thereof, to generate, based at least in part on the multi-dimensional refined resource unit development structure, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component.

In some embodiments, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component include at least one of a plurality of resource unit development items.

In some embodiments, generating one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component includes selecting at least one of a plurality of resource unit development items based at least in part on at least one predicted resource unit development link.

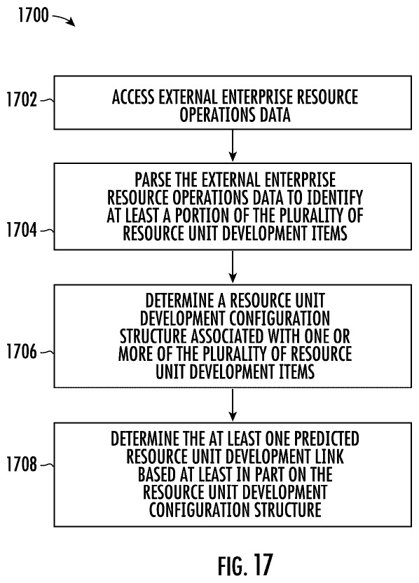

FIG. 17 is a flowchart broadly illustrating a series of operations or process blocks that are executed or performed to performing a resource unit development refinement operation in a resource unit development operation system in accordance with some example embodiments of the present disclosure. In some embodiments, the method 1700 is embodied by computer program code stored on a non-transitory computer-readable storage medium of a computer program product configured for execution to perform the process as depicted and described. In this regard, in some such embodiments, the resource unit development operation server 210 is specially configured by computer-coded instructions (e.g., computer program instructions) stored thereon, for example in the memory 201 and/or another component depicted and/or described herein and/or otherwise accessible to the resource unit development operation server 210, for performing the operations as depicted and described. Alternatively, or additionally, in some embodiments, the method 1700 is performed by one or more specially configured computing devices, such as the resource unit development operation server 210 alone or in communication with one or more other component(s), device(s), system(s), and/or the like. For example, in some embodiments, the resource unit development operation server 210 is in communication with one or more external apparatus(es), system(s), device(s), and/or the like, to perform one or more of the operations as depicted and described. For purposes of simplifying the description, the method 1700 is described as performed by and from the perspective of the resource unit development operation server 210. In this regard, performance of the operations may invoke one or more of memory 201, processor 202, input/output circuitry 203, communications circuitry 204, and/or resource unit development operation circuitry 205.

In the embodiment illustrated in FIG. 17, the flowchart illustrates method 1700 which begins at block 1702. At block 1702, the resource unit development operation server 210 includes means, such as the memory 201, processor 202, input/output circuitry 203, communications circuitry 204, and/or resource unit development operation circuitry 205, or a combination thereof, to access external enterprise resource operations data. In some embodiments, external enterprise resource operations data may be one or more items of data indicative and/or representative of at least a portion of one or more resource unit development items. In some embodiments, the portion of one or more resource unit development items may be associated with an enterprise associated with a resource unit development operation system. For example, external enterprise resource operations data may be one or more items of data indicative and/or representative of one or more resource unit development user identifier items associated with an enterprise from one or more resource unit development items. In some embodiments, external enterprise resource operations data may be stored in an external enterprise resource operations data repository. In some embodiments, a resource unit development operation system may be configured to parse external enterprise resource operations data.

At block 1704, the resource unit development operation server 210 includes means, such as the memory 201, processor 202, input/output circuitry 203, communications circuitry 204, and/or resource unit development operation circuitry 205, or a combination thereof, to parse the external enterprise resource operations data to identify at least a portion of the plurality of resource unit development items.

At block 1706, the resource unit development operation server 210 includes means, such as the memory 201, processor 202, input/output circuitry 203, communications circuitry 204, and/or resource unit development operation circuitry 205, or a combination thereof, to determine a resource unit development configuration structure associated with one or more of the plurality of resource unit development items. In some embodiments, a resource unit development configuration structure may be a domain-specific data structure of an aggregation of at least a portion of one or more resource unit development items configured in an at least partially ordered structure in a resource unit development operation system. In some embodiments, the portion of one or more resource unit development items may be associated with an enterprise associated with a resource unit development operation system. For example, a resource unit development configuration structure may be a domain-specific data structure of an aggregation of one or more resource unit development user identifier items associated with an enterprise from one or more resource unit development items configured in an at least partially ordered structure in a resource unit development operation system. In some embodiments, a resource unit development operation system may be configured to determine a resource unit development configuration structure. In some embodiments, a resource unit development operation system may be configured to determine one or more predicted resource unit development links based at least in part on a resource unit development configuration structure.

At block 1708, the resource unit development operation server 210 includes means, such as the memory 201, processor 202, input/output circuitry 203, communications circuitry 204, and/or resource unit development operation circuitry 205, or a combination thereof, to determine the at least one predicted resource unit development link based at least in part on the resource unit development configuration structure.

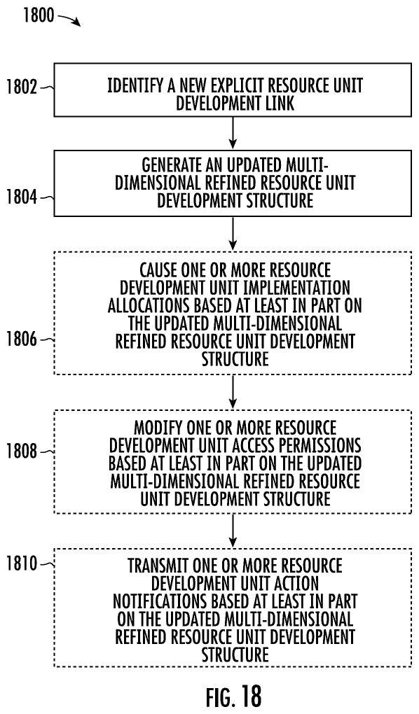

FIG. 18 is a flowchart broadly illustrating a series of operations or process blocks that are executed or performed to generating an updated multi-dimensional refine resource unit development structure based at least in part on an identified new explicit resource unit development link in a resource unit development operation system in accordance with some example embodiments of the present disclosure. In some embodiments, the method 1800 is embodied by computer program code stored on a non-transitory computer-readable storage medium of a computer program product configured for execution to perform the process as depicted and described. In this regard, in some such embodiments, the resource unit development operation server 210 is specially configured by computer-coded instructions (e.g., computer program instructions) stored thereon, for example in the memory 201 and/or another component depicted and/or described herein and/or otherwise accessible to the resource unit development operation server 210, for performing the operations as depicted and described. Alternatively, or additionally, in some embodiments, the method 1800 is performed by one or more specially configured computing devices, such as the resource unit development operation server 210 alone or in communication with one or more other component(s), device(s), system(s), and/or the like. For example, in some embodiments, the resource unit development operation server 210 is in communication with one or more external apparatus(es), system(s), device(s), and/or the like, to perform one or more of the operations as depicted and described. For purposes of simplifying the description, the method 1800 is described as performed by and from the perspective of the resource unit development operation server 210. In this regard, performance of the operations may invoke one or more of memory 201, processor 202, input/output circuitry 203, communications circuitry 204, and/or resource unit development operation circuitry 205.

In the embodiment illustrated in FIG. 18, the flowchart illustrates method 1800 which begins at block 1802. At block 1802, the resource unit development operation server 210 includes means, such as the memory 201, processor 202, input/output circuitry 203, communications circuitry 204, and/or resource unit development operation circuitry 205, or a combination thereof, to identify a new explicit resource unit development link.

In some embodiments, a new explicit resource unit development link may be a data object representative of and/or associated with a new link, new connection, new relationship, new association, new bond, and/or the like between one or more new resource unit development items that was defined at the generation of the one or more new resource unit development items. In some embodiments, a new explicit resource unit development link may be a data object representative of and/or associated with a new link, new connection, new relationship, new association, new bond, and/or the like between one or more new resource unit development items that are in the same refinement candidate resource unit development structure. For example, a new explicit resource unit development link may be data object representative of and/or associated with a new link, new connection, new relationship, new association, new bond, and/or the like between a first new resource unit development item associated with a first refinement candidate resource unit development structure and a second new resource unit development item associated with the first refinement candidate resource unit development structure.

At block 1804, the resource unit development operation server 210 includes means, such as the memory 201, processor 202, input/output circuitry 203, communications circuitry 204, and/or resource unit development operation circuitry 205, or a combination thereof, to generate an updated multi-dimensional refined resource unit development structure. In some embodiments, an updated multi-dimensional refined resource unit development structure may be an updated domain-specific data structure of an aggregation of resource unit development items, a domain-specific data structure of an aggregation of new resource unit development items, a domain-specific data structure of an aggregation of predicted resource unit development links, a domain-specific data structure of an aggregation of new predicted resource unit development links, a domain-specific data structure of an aggregation of new explicit resource unit development links (e.g., an identified new explicit resource unit development link) and/or a domain-specific data structure of an aggregation of explicit resource unit development links in a resource unit development operation system.

At optional block 1806, the resource unit development operation server 210 includes means, such as the memory 201, processor 202, input/output circuitry 203, communications circuitry 204, and/or resource unit development operation circuitry 205, or a combination thereof, to cause one or more resource development unit implementation allocations based at least in part on the updated multi-dimensional refined resource unit development structure.

In some embodiments, a resource development unit implementation allocation may be a data object representative of and/or associated with an action performed by a resource unit development operation system that includes causing allocation of resources, allocations, tools, data, items, and/or the like. In some embodiments, a resource development unit implementation allocation may be based at least in part on a multi-dimensional refined resource unit development structure. In some embodiments, a resource development unit implementation allocation may be based at least in part on a multi-dimensional refined resource unit development structure. In this regard, a resource development unit implementation allocation may be caused based at least in part on a resource unit development operation system generating an updated multi-dimensional refined resource unit development structure.

At optional block 1808, the resource unit development operation server 210 includes means, such as the memory 201, processor 202, input/output circuitry 203, communications circuitry 204, and/or resource unit development operation circuitry 205, or a combination thereof, to modify one or more resource development unit access permissions based at least in part on the updated multi-dimensional refined resource unit development structure.

In some embodiments, a resource development unit access permission may be a data object representative of and/or associated with an action performed by a resource unit development operation system that includes modifying one or more access permissions associated with a multi-dimensional refined resource unit development structure. In some embodiments, a resource development unit access permission may be based at least in part on a multi-dimensional refined resource unit development structure. In some embodiments, a resource development unit access permission may be based at least in part on a multi-dimensional refined resource unit development structure. In this regard, a resource development unit access permission may be modified based at least in part on a resource unit development operation system generating an updated multi-dimensional refined resource unit development structure.

At optional block 1810, the resource unit development operation server 210 includes means, such as the memory 201, processor 202, input/output circuitry 203, communications circuitry 204, and/or resource unit development operation circuitry 205, or a combination thereof, to transmit one or more resource development unit action notifications based at least in part on the updated multi-dimensional refined resource unit development structure.

In some embodiments, a resource development unit action notification may be a data object representative of and/or associated with an action performed by a resource unit development operation system that includes transmitting a notification. In some embodiments, resource development unit action notification and/or an updated multi-dimensional refined resource unit development structure. In this regard, a resource development unit action notification may be modified based at least in part on a resource unit development operation system generating an updated multi-dimensional refined resource unit development structure.

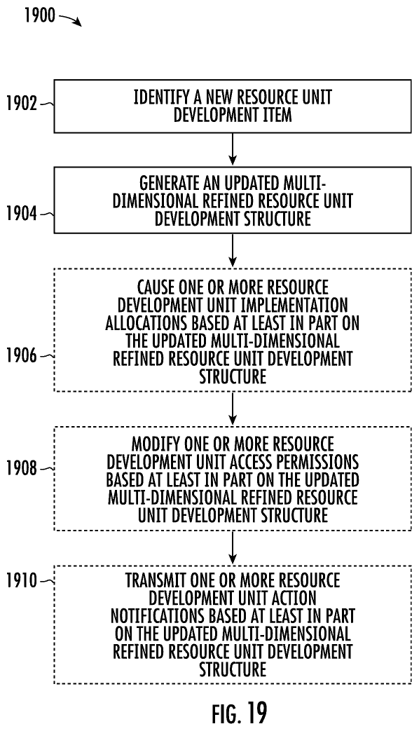

FIG. 19 is a flowchart broadly illustrating a series of operations or process blocks that are executed or performed to generating an updated multi-dimensional refine resource unit development structure based at least in part on an identified new resource unit development item in a resource unit development operation system in accordance with some example embodiments of the present disclosure. In some embodiments, the method 1900 is embodied by computer program code stored on a non-transitory computer-readable storage medium of a computer program product configured for execution to perform the process as depicted and described. In this regard, in some such embodiments, the resource unit development operation server 210 is specially configured by computer-coded instructions (e.g., computer program instructions) stored thereon, for example in the memory 201 and/or another component depicted and/or described herein and/or otherwise accessible to the resource unit development operation server 210, for performing the operations as depicted and described. Alternatively, or additionally, in some embodiments, the method 1900 is performed by one or more specially configured computing devices, such as the resource unit development operation server 210 alone or in communication with one or more other component(s), device(s), system(s), and/or the like. For example, in some embodiments, the resource unit development operation server 210 is in communication with one or more external apparatus(es), system(s), device(s), and/or the like, to perform one or more of the operations as depicted and described. For purposes of simplifying the description, the method 1900 is described as performed by and from the perspective of the resource unit development operation server 210. In this regard, performance of the operations may invoke one or more of memory 201, processor 202, input/output circuitry 203, communications circuitry 204, and/or resource unit development operation circuitry 205.

In the embodiment illustrated in FIG. 19, the flowchart illustrates method 1900 which begins at block 1902. At block 1902, the resource unit development operation server 210 includes means, such as the memory 201, processor 202, input/output circuitry 203, communications circuitry 204, and/or resource unit development operation circuitry 205, or a combination thereof, to identify a new resource unit development item.

In some embodiments, a new resource unit development item may be a data object representative of and/or associated with a new project, a new user, a new team, a new objective, a new milestone, and/or a new allocation. For example, a new resource unit development item may include or correspond to a new resource unit development project identifier item, new resource unit development user identifier item, new resource unit development team identifier item, new resource unit development objective identifier item, new resource unit development milestone identifier item, and/or a new resource unit development allocation identifier item. In some embodiments, a resource unit development operation system may be configured to identify a new resource unit development item. For example, a resource unit development operation system may be configured to identify a new resource unit development item based on an input provided to a resource unit development operation system. In some embodiments, a resource unit development operation system may be configured to generate an updated multi-dimensional refined resource unit development structure based at least in part on a new resource unit development item.

At block 1904, the resource unit development operation server 210 includes means, such as the memory 201, processor 202, input/output circuitry 203, communications circuitry 204, and/or resource unit development operation circuitry 205, or a combination thereof, to generate an updated multi-dimensional refined resource unit development structure. In some embodiments, an updated multi-dimensional refined resource unit development structure may be an updated domain-specific data structure of an aggregation of resource unit development items, a domain-specific data structure of an aggregation of new resource unit development items (e.g., an identified new resource unit development item), a domain-specific data structure of an aggregation of predicted resource unit development links, a domain-specific data structure of an aggregation of new predicted resource unit development links, a domain-specific data structure of an aggregation of new explicit resource unit development links and/or a domain-specific data structure of an aggregation of explicit resource unit development links in a resource unit development operation system.

At optional block 1906, the resource unit development operation server 210 includes means, such as the memory 201, processor 202, input/output circuitry 203, communications circuitry 204, and/or resource unit development operation circuitry 205, or a combination thereof, to cause one or more resource development unit implementation allocations based at least in part on the updated multi-dimensional refined resource unit development structure.

In some embodiments, a resource development unit implementation allocation may be a data object representative of and/or associated with an action performed by a resource unit development operation system that includes causing allocation of resources, allocations, tools, data, items, and/or the like. In some embodiments, a resource development unit implementation allocation may be based at least in part on a multi-dimensional refined resource unit development structure. In some embodiments, a resource development unit implementation allocation may be based at least in part on a multi-dimensional refined resource unit development structure. In this regard, a resource development unit implementation allocation may be caused based at least in part on a resource unit development operation system generating an updated multi-dimensional refined resource unit development structure.

At optional block 1908, the resource unit development operation server 210 includes means, such as the memory 201, processor 202, input/output circuitry 203, communications circuitry 204, and/or resource unit development operation circuitry 205, or a combination thereof, to modify one or more resource development unit access permissions based at least in part on the updated multi-dimensional refined resource unit development structure.

In some embodiments, a resource development unit access permission may be a data object representative of and/or associated with an action performed by a resource unit development operation system that includes modifying one or more access permissions associated with a multi-dimensional refined resource unit development structure. In some embodiments, a resource development unit access permission may be based at least in part on a multi-dimensional refined resource unit development structure. In some embodiments, a resource development unit access permission may be based at least in part on a multi-dimensional refined resource unit development structure. In this regard, a resource development unit access permission may be modified based at least in part on a resource unit development operation system generating an updated multi-dimensional refined resource unit development structure.

At optional block 1910, the resource unit development operation server 210 includes means, such as the memory 201, processor 202, input/output circuitry 203, communications circuitry 204, and/or resource unit development operation circuitry 205, or a combination thereof, to transmit one or more resource development unit action notifications based at least in part on the updated multi-dimensional refined resource unit development structure.

In some embodiments, a resource development unit action notification may be a data object representative of and/or associated with an action performed by a resource unit development operation system that includes transmitting a notification. In some embodiments, resource development unit action notification and/or an updated multi-dimensional refined resource unit development structure. In this regard, a resource development unit action notification may be modified based at least in part on a resource unit development operation system generating an updated multi-dimensional refined resource unit development structure.

FIGS. 16, 17, 18, and 19 thus illustrate flowcharts describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the resource unit development operation server 210 and executed by a processor 202 of the resource unit development operation server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting a resource development generation interface component to a resource operational interface, the apparatus comprising at least one processor, and at least one memory including program code, the at least one memory and the program code configured to, with the at least one processor, cause the apparatus to at least:
access resource unit development data representative of a plurality of refinement candidate resource unit development structures, wherein one or more of the plurality of refinement candidate resource unit development structures comprise at least one of a plurality of resource unit development items and at least one of a plurality of explicit resource unit development links;
generate a multi-dimensional refined resource unit development structure comprising the plurality of resource unit development items, the plurality of explicit resource unit development links, and at least one predicted resource unit development link, wherein generating the multi-dimensional refined resource unit development structure comprises determining the at least one predicted resource unit development link;
generate a resource development generation interface component based at least in part on the multi-dimensional refined resource unit development structure, wherein the resource development generation interface component comprises at least one of the plurality of resource unit development items, wherein generating the resource development generation interface component comprises selecting the at least one of the plurality of resource unit development items based at least in part on the at least one predicted resource unit development link; and
output the resource development generation interface component for rendering to a resource operational interface of a computing device.

2. The apparatus of claim 1, wherein determining the at least one predicted resource unit development link comprises the program code being further configured to, with the at least one processor, further cause the apparatus to:
perform a resource unit development refinement operation.

3. The apparatus of claim 2, wherein performing a resource unit development refinement operation comprises the program code being further configured to, with the at least one processor, further cause the apparatus to:
access external enterprise resource operations data;
parse the external enterprise resource operations data to identify at least a portion of the plurality of resource unit development items;
determine a resource unit development configuration structure associated with one or more of the plurality of resource unit development items; and
determine the at least one predicted resource unit development link based at least in part on the resource unit development configuration structure.

4. The apparatus of claim 1, wherein the at least one predicted resource unit development link is determined using a resource unit development link prediction model.

5. The apparatus of claim 1, wherein the resource development generation interface component is generated based at least in part on an operations resource generation query.

6. The apparatus of claim 1, wherein the plurality of resource unit development items comprises one or more of a resource unit development project identifier item, a resource unit development user identifier item, a resource unit development team identifier item, a resource unit development objective identifier item, a resource unit development milestone identifier item, a resource unit development allocation identifier item.

7. The apparatus of claim 1, wherein the program code is further configured to, with the at least one processor, cause the apparatus to:
identify a new explicit resource unit development link; and
generate an updated multi-dimensional refined resource unit development structure comprising the plurality of resource unit development items, the plurality of explicit resource unit development links, new explicit resource unit development link, the at least one predicted resource unit development link, and at least one new predicted resource unit development link, wherein generating the updated multi-dimensional refined resource unit development structure comprises determining the at least one new predicted resource unit development link.

8. The apparatus of claim 1, wherein the program code is further configured to, with the at least one processor, cause the apparatus to:
identify a new resource unit development item; and
generate an updated multi-dimensional refined resource unit development structure comprising the plurality of resource unit development items, the new resource unit development item, the plurality of explicit resource unit development links, the at least one predicted resource unit development link, and at least one new predicted resource unit development link, wherein generating the updated multi-dimensional refined resource unit development structure comprises determining the at least one new predicted resource unit development link.

9. The apparatus of claim 8, wherein the program code is further configured to, with the at least one processor, cause the apparatus to:
cause one or more resource development unit implementation allocations based at least in part on the updated multi-dimensional refined resource unit development structure.

10. The apparatus of claim 8, wherein the program code is further configured to, with the at least one processor, cause the apparatus to:
modify one or more resource development unit access permissions based at least in part on the updated multi-dimensional refined resource unit development structure.

11. The apparatus of claim 8, wherein the program code is further configured to, with the at least one processor, cause the apparatus to:
transmit one or more resource development unit action notifications based at least in part on the updated multi-dimensional refined resource unit development structure.

12. The apparatus of claim 1, wherein the program code is further configured to, with the at least one processor, cause the apparatus to:
generate, based at least in part on the multi-dimensional refined resource unit development structure, one or more of a resource development individual generation interface component, a resource development enterprise communication generation interface component, a resource development team communication generation interface component, a resource development summary generation interface component, a resource development aggregated impact interface component, a resource development impact interface component, a resource development aggregated implementation interface component, or a resource development implementation interface component.

13. A method for outputting a resource development generation interface component to a resource operational interface, the method comprising:
accessing resource unit development data representative of a plurality of refinement candidate resource unit development structures, wherein one or more of the plurality of refinement candidate resource unit development structures comprise at least one of a plurality of resource unit development items and at least one of a plurality of explicit resource unit development links;
generating a multi-dimensional refined resource unit development structure comprising the plurality of resource unit development items, the plurality of explicit resource unit development links, and at least one predicted resource unit development link, wherein generating the multi-dimensional refined resource unit development structure comprises determining the at least one predicted resource unit development link;
generating a resource development generation interface component based at least in part on the multi-dimensional refined resource unit development structure, wherein the resource development generation interface component comprises at least one of the plurality of resource unit development items, wherein generating the resource development generation interface component comprises selecting the at least one of the plurality of resource unit development items based at least in part on the at least one predicted resource unit development link; and
outputting the resource development generation interface component for rendering to a resource operational interface of a computing device.

14. The method of claim 13, wherein determining the at least one predicted resource unit development link comprises:
performing a resource unit development refinement operation.

15. The method of claim 14, wherein performing a resource unit development refinement operation comprises:
accessing external enterprise resource operations data;
parsing the external enterprise resource operations data to identify at least a portion of the plurality of resource unit development items;
determining a resource unit development configuration structure associated with one or more of the plurality of resource unit development items; and
determining the at least one predicted resource unit development link based at least in part on the resource unit development configuration structure.

16. The method of claim 13, wherein the at least one predicted resource unit development link is determined using a resource unit development link prediction model.

17. The method of claim 13, wherein the plurality of resource unit development items comprises one or more of a resource unit development project identifier item, a resource unit development user identifier item, a resource unit development team identifier item, a resource unit development objective identifier item, a resource unit development milestone identifier item, a resource unit development allocation identifier item.

18. The method of claim 13, further comprising:
identifying a new resource unit development item; and
generating an updated multi-dimensional refined resource unit development structure comprising the plurality of resource unit development items, the new resource unit development item, the plurality of explicit resource unit development links, the at least one predicted resource unit development link, and at least one new predicted resource unit development link, wherein generating the updated multi-dimensional refined resource unit development structure comprises determining the at least one new predicted resource unit development link.

19. The method of claim 18, further comprising:
causing one or more resource development unit implementation allocations based at least in part on the updated multi-dimensional refined resource unit development structure.

20. A computer program product for outputting a resource development generation interface component to a resource operational interface, the computer program product comprising at least one non-transitory computer-readable storage medium having computer-readable program code portions stored therein, the computer-readable program code portions comprising an executable portion configured to:
access resource unit development data representative of a plurality of refinement candidate resource unit development structures, wherein one or more of the plurality of refinement candidate resource unit development structures comprise at least one of a plurality of resource unit development items and at least one of a plurality of explicit resource unit development links;
generate a multi-dimensional refined resource unit development structure comprising the plurality of resource unit development items, the plurality of explicit resource unit development links, and at least one predicted resource unit development link, wherein generating the multi-dimensional refined resource unit development structure comprises determining the at least one predicted resource unit development link;
generate a resource development generation interface component based at least in part on the multi-dimensional refined resource unit development structure, wherein the resource development generation interface component comprises at least one of the plurality of resource unit development items, wherein generating the resource development generation interface component comprises selecting the at least one of the plurality of resource unit development items based at least in part on the at least one predicted resource unit development link; and
output the resource development generation interface component for rendering to a resource operational interface of a computing device.
